(19) United States
(12) Patent Application Publication
(10) Pub. No.: US 2009/0203867 A1
(43) Pub. Date: Aug. 13, 2009

(54) METHODS FOR THE SYNTHESIS OF MODULAR POLY(PHENYLENEETHYNYLENES) AND FINE TUNING THE ELECTRONIC PROPERTIES THEREOF FOR THE FUNCTIONALIZATION OF NANOMATERIALS

(75) Inventors: Hassan Ait-Haddou, Plano, TX (US); Marni Rutkofsky, Plano, TX (US)

Correspondence Address: HAYNES AND BOONE, LLP;IP Section, 2323 Victory Avenue, Suite 700, Dallas, TX, 75219, US

(73) Assignee: ZYVEX PERFORMANCE MATERIALS, INC., Columbus, OH (US)

(21) Appl. No.: 12/423,611

(22) Filed: Apr. 14, 2009

Related U.S. Application Data
(62) Division of application No. 11/105,078, filed on Apr. 13, 2005.
(60) Provisional application No. 60/561,562, filed on Apr. 13, 2004.

(51) Int. Cl. C08F 38/00

(52) U.S. Cl. 526/259; 526/285

(57) ABSTRACT

Poly(aryleneethynylene) polymers for exfoliating and dispersing/solubilizing nanomaterial are provided herein. The poly(aryleneethynylene) polymers have unit monomer portions, each monomer portion having at least one electron donating substituent thereby forming an electron donor monomer portion, or at least one electron withdrawing substituent thereby forming an electron accepting monomer portion. Such polymers exfoliate and disperse nanomaterial without presonication of the nanomaterial.

The present application is a divisional of U.S. patent application Ser. No. 11/105,078 filed Apr. 13, 2005, which claims the benefit of U.S. Ser. No. 60/561,562 filed Apr. 13, 2004, the entire disclosures of which are incorporated by reference herein.

### TECHNICAL FIELD

The present disclosure is related to methods for exfoliation and dispersion/solubilization of nanomaterials, modular polymers for dispersion of nanomaterials, methods for preparing such polymers, and products using exfoliated and dispersed nanomaterial.

### BACKGROUND

Boron nitride nanotubes and methods for their manufacture are known to those of ordinary skill in the art. See e.g., Han et al., Synthesis of boron nitride nanotubes from carbon nanotubes by a substitution reaction, Applied Physics Letters Vol. 73(21) pp. 3085-3087. Nov. 23, 1998; Y. Chen et al., Mechanochemical Synthesis of Boron Nitride Nanotubes, Materials Science Forum Vols. 312-314 (1999) pp. 173-178; Journal of Metastable and Nanocrystalline Materials Vols. 2-6 (1999) pp. 173-178. 173; 1999 Trans Tech Publications, Switzerland.

Carbon nanotubes and methods for their manufacture are also known to those of ordinary skill in the art. In general, carbon nanotubes are elongated tubular bodies which are typically only a few atoms in circumference. The carbon nanotubes are hollow and have a linear fullerene structure. The length of the carbon nanotubes potentially may be millions of times greater than their molecular-sized diameter. Both single-walled carbon nanotubes (SWNTs), as well as multi-walled carbon nanotubes (MWNTs) have been recognized.

Carbon nanotubes are currently being proposed for a number of applications since they possess a very desirable and unique combination of physical properties relating to, for example, strength and weight. Carbon nanotubes have also demonstrated electrical conductivity. See Yakobson, B. I., et al., American Scientist, 85, (1997), 324-337; and Dresselhaus, M. S., et al., Science of Fullerenes and Carbon Nanotubes, 1996, San Diego: Academic Press, pp. 902-905. For example, carbon nanotubes conduct heat and electricity better than copper or gold and have 100 times the tensile strength but only a sixth of the weight of steel. Carbon nanotubes may be produced having extraordinarily small size. For example, carbon nanotubes are being produced that are approximately the size of a DNA double helix (or approximately 1/50,000^{th} the width of a human hair).

Various techniques for producing carbon nanotubes have been developed. As examples, methods of forming carbon nanotubes are described in U.S. Pat. Nos. 5,753,088 and 5,482,601, the disclosures of which are hereby incorporated herein by reference. Three common techniques for producing carbon nanotubes are: 1) laser vaporization technique, 2) electric arc technique, and 3) gas phase technique (e.g., HiPco™ process), which are discussed further below.

In general, the “laser vaporization” technique utilizes a pulsed laser to vaporize graphite in producing the carbon nanotubes. The laser vaporization technique is further described by A. G. Rinzler et al. in Appl. Phys. A, 1998, 67, 29. Generally, the laser vaporization technique produces carbon nanotubes that have a diameter of approximately 1.1 to 1.3 nanometers (nm).

Another technique for producing carbon nanotubes is the “electric arc” technique in which carbon nanotubes are synthesized utilizing an electric arc discharge. As an example, single-walled nanotubes (SWNTs) may be synthesized by an electric arc discharge under helium atmosphere with the graphite anode filled with a mixture of metallic catalysts and graphite powder (Ni:Y:C), as described more fully by C. Joumet et al. in Nature (London), 388 (1997), 756. Typically, such SWNTs are produced as close-packed bundles (or “ropes”) with such bundles having diameters ranging from 5 to 20 nm. Generally, the SWNTs are well-aligned in a two-dimensional periodic triangular lattice bonded by van der Waals interactions. The electric arc technique of producing carbon nanotubes is further described by C. Journet and P. Bernier in Appl. Phys. A, 67, 1. Utilizing such an electric arc technique, the average carbon nanotube diameter is typically approximately 1.3 to 1.5 nm and the triangular lattice parameter is approximately 1.7 nm.

Another technique for producing carbon nanotubes is the “gas phase” technique, which produces greater quantities of carbon nanotubes than the laser vaporization and electric arc production techniques. The gas phase technique, which is referred to as the HiPco™ process, produces carbon nanotubes utilizing a gas phase catalytic reaction. The HiPco™ process uses basic industrial gas (carbon monoxide), under temperature and pressure conditions common in modern industrial plants to construct relatively high quantities of high-purity carbon nanotubes that are essentially free of by-products. The HiPco process is described in further detail by P. Nikolaev et al. in Chem. Phys. Lett., 1999, 313, 91.

The processes described above, and other currently known processes for the preparation of carbon nanotubes, produce “pure” nanotubes, which are not dispersible or soluble. However, covalent side-wall functionalization of such “pure” carbon nanotubes can lead to the dissolution of carbon nanotubes in organic solvents. It should be noted that the terms “dissolution” and “solubilization” are used interchangeably herein. See Boul, P. J et al., Chem. Phys. Lett. 1999, 310, 367 and Georgakilas, V. et al., J. Am. Chem. Soc. 2002, 124, 760-761. The disadvantage of a covalent side-wall approach is that a carbon nanotube's intrinsic properties are changed significantly by covalent side-wall functionalizations.

Carbon nanotubes can also be solubilized in organic solvents and water by polymer wrapping. See Dalton, A. B. et al., J. Phys. Chem. B 2000, 104, 10012-10016, Star, A. et al. Angew. Chem., Int. Ed. 2001, 40, 1721-1725, and O'Connell, M. J et al. Chem. Phys. Lett. 2001, 342, 265-271. In polymer wrapping, a polymer “wraps” around the diameter of a carbon nanotube. One disadvantage of this approach is that the polymer is very inefficient in wrapping the small-diameter single-walled carbon nanotubes produced by the HiPco process because of high strain conformation required for the polymer.

Single-walled nanotubes (SWNTs) have been noncovalently functionalized by adhesion of small molecules for protein immobilization (Chen et al., (J. Am. Chem. Soc. 123:3838 (2001))).

A process of noncovalent functionalization and solubilization of carbon nanotubes is described by Chen, J. et al. (J. Am. Chem. Soc., 124, 9034 (2002)) which process results in excellent nanotube dispersion using a nonwrapping approach. SWNTs were solubilized in chloroform with poly(phenyleneethynylene)s (PPE) along with vigorous shaking and/or short bath-sonication as described by Chen et al. (ibid) and in U.S. Patent Publication No. U.S. 2004/0034177 published Feb. 19, 2004, and U.S. patent application Ser. No. 10/318,730 filed Dec. 13, 2002; the contents of such patent applications are incorporated by reference herein in their entirety. The major interaction between the polymer backbone and the nanotube surface is described as parallel π-stacking. Thin film visible and near-infrared spectroscopy of PPE-solubilized nanomaterial demonstrated that the electronic structures are basically intact after solubilization. One such PPE-solubilized nanomaterial sample was obtained by filtration and redissolved in chloroform to a concentration of about 0.1 to 0.2 mg/mL (Chen et al. (ibid) and in U.S. Patent Publication No. U.S. 2004/0034177 published Feb. 19, 2004, and U.S. patent application Ser. No. 10/318,730 filed Dec. 13, 2002).

Further rigid polymers for exfoliating and dispersing/solubilizing nanomaterials, compositions, and methods therefor are described herein.

### SUMMARY OF THE INVENTION

The present disclosure is directed to methods for the exfoliation and dispersion/solubilization of exfoliated nanomaterial to form a dispersion of exfoliated nanomaterial. Nanomaterial is typically bundled or roped, which bundles or ropes must be undone at least in part, i.e., exfoliated, to enable the dispersion/solubilization and functionalization of the nanomaterial. The method comprises mixing nanomaterial, a poly(aryleneethynylene) having a polymer backbone of “n” monomer units, each monomer unit comprising at least two monomer portions, wherein each monomer portion has at least one electron donating substituent or at least one electron withdrawing substituent, and wherein “n” is from about 5 to about 190, and a dispersion solvent to form a solution. In particular, the poly(aryleneethynylene) is a poly(phenyleneethynylenes). Embodiments further provide for fine-tuning of dispersion behavior by having manipulation groups on the peripheral substituents of the polymers.

A further embodiment of the invention is forming a solution of nanomaterial using a poly(aryleneethynylene) wherein the monomer unit thereof contains greater than two monomer portions, each monomer portion has at least one electron donating substituent or at least one electron withdrawing substituent, at least one monomer portion has at least one electron donating substituent and at least one monomer portion has at least one electron withdrawing substituent; and the poly(aryleneethynylene) has other than a 1:1 ratio of donor monomer portions to acceptor monomer portions. In particular, donor/acceptor monomer portion molar ratio of 3:1, 7:1, 1:3, or 1:7 are provided.

A composition comprising a poly(aryleneethynylene) having a polymer backbone of “n” monomer units, wherein each monomer unit comprises at least two monomer portions, each monomer portion has at least one electron donating substituent or at least one electron withdrawing substituent, at least one of the electron donating substituent and the electron withdrawing substituent is bound to an alkyl, phenyl, benzyl, aryl, allyl or H group, and each alkyl, phenyl, benzyl, aryl, or allyl group is further bound to a group Z, is a further embodiment of the invention. In this embodiment, substituent Z is independently an acetal, acid halide, acrylate unit, acyl azide, aldehyde, anhydride, cyclic alkene, arene, alkene, alkyne, alkyl halide, aryl, aryl halide, amine, amide, amino, amino acid, alcohol, alkoxy, antibiotic, azide, aziridine, azo compounds, calixarene, carbohydrate, carbonate, carboxylic acid, carboxylate, carbodiimide, cyclodextrin, crown ether, CN, cryptand, dendrimer, dendron, diamine, diaminopyridine, diazonium compounds, DNA, epoxy, ester, ether, epoxide, ethylene glycol, fullerene, glyoxal, halide, hydroxy, imide, imine, imidoester, ketone, nitrile, isothiocyanate, isocyanate, isonitrile, ketone, lactone, ligand for metal complexation, ligand for biomolecule complexation, lipid, maleimide, melamine, metallocene, NHS ester, nitroalkane, nitro compounds, nucleotide, olefin, oligosaccharide, peptide, phenol, phthalocyanine, porphyrin, phosphine, phosphonate, polyamine, polyethoxyalkyl, 2,2′-bipyridine, 1,10-phenanthroline, terpyridine, pyridazine, pyrimidine, purine, pyrazine, 1,8-naphthyridine, polyhedral oligomeric silsequioxane (POSS), pyrazolate, imidazolate, torand, hexapyridine, 4,4′-bipyrimidine, polypropoxyalkyl, protein, pyridine, quaternary ammonium salt, quaternary phosphonium salt, quinone, RNA, Schiff base, selenide, sepulchrate, silane, a styrene unit, sulfide, sulfone, sulfhydryl, sulfonyl chloride, sulfonic acid, sulfonic acid ester, sulfonium salt, sulfoxide, sulfur and selenium compounds, thiol, thioether, thiol acid, thio ester, thymine, or a combination thereof.

Modular polymers of the present embodiments have a length of between about and including any of 20 nm, 25 nm, 30 nm, 35 nm, 40 nm, 45 nm, 50 nm, 55 nm, 60 nm, 65 nm, 70 nm, 75 nm, 80 nm, 85 nm, 90 nm, 95 nm, 100 nm, 110 nm, 120 nm, 130 nm, 140 nm, 150 nm, 160 nm, 170 nm, 180 nm, 190 nm, and 200 nm. Modular polymers of the present embodiments have a number of polymer repeating units depending upon the length of each monomer unit. The number of repeating units can be calculated based upon the length of the monomer. One benzene ring together with one triple bond has a length of about 5.4 Å. Therefore, a length of a monomer unit of FIG. 2, for example, is about 10.8 Å. Twenty to about 190 of such repeating units provides a polymer length of about 22 nm to about 200 nm. The length of monomer unit of Scheme 6 having eight monomer portions is about 43 nm. Therefore, the number of monomer units for a length of about 200 nm is about 5. In certain embodiments, the number of repeating units is equal to or within a range of any of the following numbers of units: 5, 10, 20, 30, 40, 50, 60, 70, 80, 90, 100, 110, 120, 130, 140, 150, 160, 170, 180, and 190. The number of repeating units is determined by proton NMR, for example.

Nanomaterial exfoliated and dispersed by a modular polymer of the present invention results in a noncovalent complex of nanomaterial and dispersing modular polymer in a dispersion/solubilization solvent. Exfoliated and dispersed nanomaterial can be subsequently removed from the dispersion or solution by removing dispersion/solubilization solvent and made into a solid (solid exfoliated nanomaterial), and then re-dispersed or re-solubilized by mixing solid exfoliated nanomaterial with a re-dispersion or re-solubilization solvent. The nanomaterial of the present embodiments was not pre-sonicated prior to exfoliation and dispersion/solubilization by modular PPE. Therefore, modular PPE provides an advantage for processing nanomaterials.

Further compositions of the present invention include a dispersion/solution of exfoliated nanomaterial, solid exfoliated nanomaterial obtained from a dispersion by removing solvent, and a re-dispersed dispersion/re-solubilized solution of exfoliated nanomaterial. The dispersion comprises nanomaterial, a modular polymer as set forth herein and a dispersion/solubilization solvent.

An article of manufacture comprising a modular polymer-dispersed exfoliated nanomaterial as described herein is a further embodiment of the present invention.

### DESCRIPTION OF THE DRAWINGS

For a more complete understanding of the present invention, reference is made to the following descriptions taken in conjunction with the accompanying drawings. It is to be expressly understood, however, that each of the figures is provided for the purpose of illustration and description only and is not intended as a definition of the limits of the present invention.

FIG. 1 provides the structure of a poly(phenyleneethynylene) (PPE) polymer.

FIG. 2. provides the structure of a PPE polymer platform of the present invention.

FIG. 3 provides another structure of a PPE polymer platform of the present invention.

FIG. 4 provides a synthesis scheme of a polymer platform such as that illustrated in FIG. 3.

FIG. 5 provides an example of manipulations that may be performed with a polymer polymerized from a platform such as polymer platform 320 of FIG. 3.

FIG. 6 provides a polymer platform having three monomer portions per monomer unit wherein manipulations of Z groups include replacement of the hydroxyl group of COOH, for example, with epoxy groups 600 and melamine groups 602.

FIG. 7 provides an example of a polymer platform 700 such as that illustrated in FIG. 2 where the Z groups of platform 220 are not present due to the substituents selected for X, Y, and R groups of platform 700.

FIG. 8A, FIG. 8B and FIG. 8C provide a synthesis scheme for a polymer platform of the present invention. FIG. 8A provides a synthetic scheme for the precursor to monomer portion 704 of platform 700, FIG. 8B provides a synthetic scheme for the precursor to monomer portion 702 of platform 700, and FIG. 8C provides polymerization of monomer portions 702 and 704 to form a PPE of the present invention.

FIG. 9 provides an example of conversion of a COOH-based PPE to an NH₂-based PPE.

FIG. 10 provides polymer platform 1000 which is polymer platform 700 where R₃ and R₄ are C₁₀H₂₁.

### DETAILED DESCRIPTION

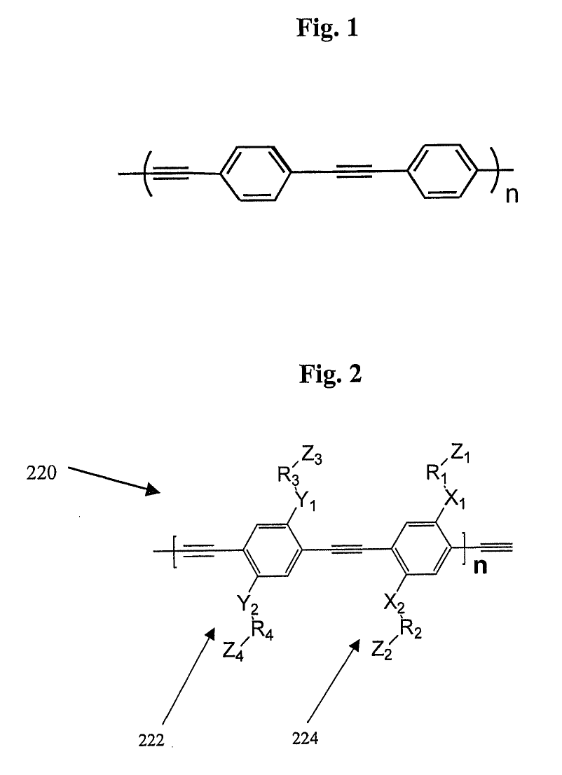

The particular polymers disclosed herein, which are used in particular methods disclosed herein, are rigid functional conjugated polymers that are based on a poly(phenyleneethynylene) structure (“PPE”) as illustrated in FIG. 1. The basic PPE structure illustrated in FIG. 1 is known to those of ordinary skill in the art. See Bunz, U.H.F. Chem. Rev. 2000, 100, 1605-1644 and McQuade, D. T. et al., J. Am. Chem. Soc. 2000, 122, 12389-12390. The polymers disclosed herein have a rigid functional conjugated backbone, as does the PPE illustrated in FIG. 1. However, the PPE polymers disclosed herein comprise backbones that provide modular monomer units having at least one electron donating substituent and one electron withdrawing substitutent, which polymers enable exfoliation of nanomaterials and dispersion in a solvent. The modular polymers have further substituents and/or side chains that affect dispersion behavior, and enhance adhesion in composites, for example. A wide variety of functionalization of modular polymers and modular polymer/nanomaterial mixtures (herein set forth as adding “Z” groups), can be performed after polymerization of the polymer and even after mixture of modular polymer with nanomaterial. Added “Z” groups may be further manipulated as described below either before or after the polymer is mixed with nanomaterials.

To exfoliate, disperse/solubilize and functionalize nanomaterials, the polymers having modular monomer units having at least one electron donating substituent or electron withdrawing substituent as described herein are mixed with the nanomaterials in a solvent, which may be water, chloroform, dichlorobenzene, and any of a number of halogenated and non-halogenated organic solvents as set forth below. The polymers associate with the nanomaterials in a non-wrapping fashion.

As used herein, “non-wrapping” means not enveloping the diameter of the nanomaterial with which a polymer is associated. Thus, associating a polymer with a nanomaterial in a “non-wrapping fashion” encompasses an association of the polymer with the nanomaterial in which the polymer does not completely envelop the diameter of the nanomaterial.

In some examples, the non-wrapping fashion may be further defined and/or restricted. For instance, in a preferred embodiment of the present invention, a polymer can associate with a nanomaterial (e.g., via π-stacking interaction therewith) wherein the polymer's backbone extends substantially along the length of the nanomaterial without any portion of the backbone extending over more than half of the nanomaterial's diameter in relation to any other portion of the polymer's backbone.

The specific rigidity of various backbones that may be implemented in polymers as described herein may vary, but such backbones are preferably sufficiently rigid such that they do not wrap (i.e., fully envelop the diameter of) nanomaterials with which they are associated. Side chains, extensions and functional groups attached to the backbone of polymers as disclosed herein may extend about all or a portion of the diameter of the nanomaterial, but the backbone of the polymer is sufficiently rigid such that it does not wrap about the diameter of nanomaterial with which it is associated.

The term “nanomaterial,” as used herein, includes, but is not limited to, multi-wall carbon (MWNTs) or boron nitride nanotubes, single-wall carbon (SWNTs) or boron nitride nanotubes, carbon or boron nitride nanoparticles, carbon or boron nitride nanofibers, carbon or boron nitride nanoropes, carbon or boron nitride nanoribbons, carbon or boron nitride nanofibrils, carbon or boron nitride nanoneedles, carbon or boron nitride nanosheets, carbon or boron nitride nanorods, carbon or boron nitride nanohoms, carbon or boron nitride nanocones, carbon or boron nitride nanoscrolls, graphite nanoplatelets, nanodots, other fullerene materials, or a combination thereof. The term “nanotubes” is used broadly herein and, unless otherwise qualified, is intended to encompass any type of nanomaterial. Generally, a “nanotube” is a tubular, strand-like structure that has a circumference on the atomic scale. For example, the diameter of single walled nanotubes typically ranges from approximately 0.4 nanometers (nm) to approximately 100 nm, and most typically have diameters ranging from approximately 0.7 nm to approximately 5 nm.

MWNTs used in the present examples are commercially available from the Arkema Group, France. SWNTs produced by a high pressure carbon monoxide process (HiPco) are available from Carbon Nanotechnologies, Inc. (Houston, Tex.). Nanomaterial made by the arc discharge, laser vaporization, or other methods known to one of skill in the art in light of the present disclosure may be used.

While the term “SWNTs,” as used herein, means single walled nanotubes, the term means that other nanomaterials as cited supra may be substituted unless otherwise stated herein.

The “arylene” of “poly(aryleneethynylene),” as used herein, means phenyl, diphenyl, naphthyl, anthracenyl, phenanthrenyl, pyridinyl, bis-pyridinyl, phenanthrolyl, pyrimidinyl, bis-pyrimidinyl, pyrazinyl, bis-pyrazinyl, aza-anthracenyl, or isomers thereof, for example.

The term “monomer portion,” as used herein, means one arylene with bound substituent groups of a modular monomer unit of PPE.

The designation “R” refers to an R group of (R_{1,2,3 or 4}), for example, an R of (R_{1,2,3 or 4}) may refer to R₁, R₂, R₃, or R₄.

Similarly, the designation “X” refers to an X substituent of (X_{1 or 2}), for example, an X of (X_{1 or 2}) may refer to X₁, or X₂; and the designation “Y” refers to a Y substituent of (Y_{1 or 2}), for example, a Y of (Y_{1 or 2}) may refer to Y₁, or Y₂.

Further, the designation “Z” refers to a Z group of (Z_{1,2,3 or 4}), for example, a Z of (R_{1,2,3 or 4}) may refer to Z₁, Z₂, Z₃, or Z₄.

A poly(phenyleneethynylene) of an embodiment of the present invention comprises structure Pₐ, P_{b}, or P_{c}:

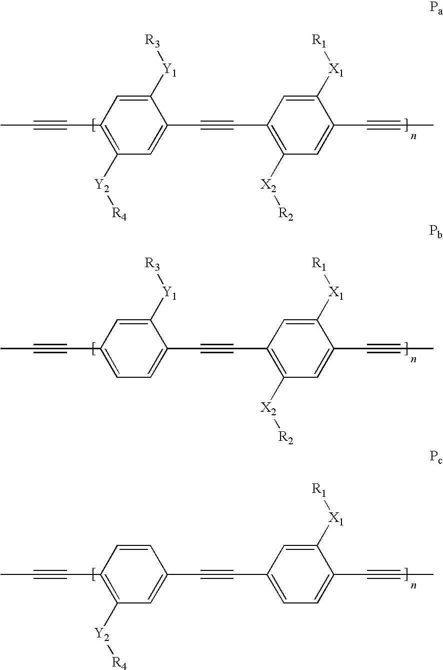

For structures Pa, Pb, and Pc, n is from about 20 to about 190. Structure Pₐ is platform 220 of FIG. 2 with (optional) Z groups absent. Structure P_{b} is platform Pₐ having a first monomer portion that is monosubstituted with Y₁R₃. Structure P_{c} is platform Pₐ having a first monomer portion that is monosubstituted with Y₂R₂ and a second monomer portion that is monosubstituted with X₁R₁. X₁R₁, X₂R₂, Y₁R₃, Y₂R₄, and Y₂R₂ are either electron donating or electron withdrawing substituents and, in particular, when the poly(phenyleneethynylene) has the structure Pₐ and when X₁R₁ and X₂R₂ are electron donating, then Y₁R₃ and Y₂R₄ are electron withdrawing; and when X₁R₁ and X₂R₂ are electron withdrawing, then Y₁R₃ and Y₂R₄ are electron donating. Further, when the poly(phenyleneethynylene) has the structure P_{b} and when X₁R₁ and X₂R₂ are electron donating, then Y₁R₃ is electron withdrawing; and when X₁R₁ and X₂R₂ are electron withdrawing, then Y₁R₃ is electron donating. In addition, when the poly(phenyleneethynylene) has the structure P_{c} and when X₁R₁ is electron donating, then Y₂R₂ is electron withdrawing, and when X₁R₁ is electron withdrawing, then Y₂R₂ is electron donating.

The term “electron withdrawing,” as used herein, means that an atom in a covalent bond has a greater tendency to attract shared electrons from the other atom. The term “electron donating,” as used herein means that an atom in a covalent bond has a greater tendency to “give-up” shared electrons to the other atom. Since each monomer unit of a poly(aryleneethynylene) as set forth herein comprises at least two monomer portions, wherein each monomer portion has at least one electron donating substituent or at least one electron withdrawing substituent, the electronic properties of the polymer are, therefore, fine-tuned.

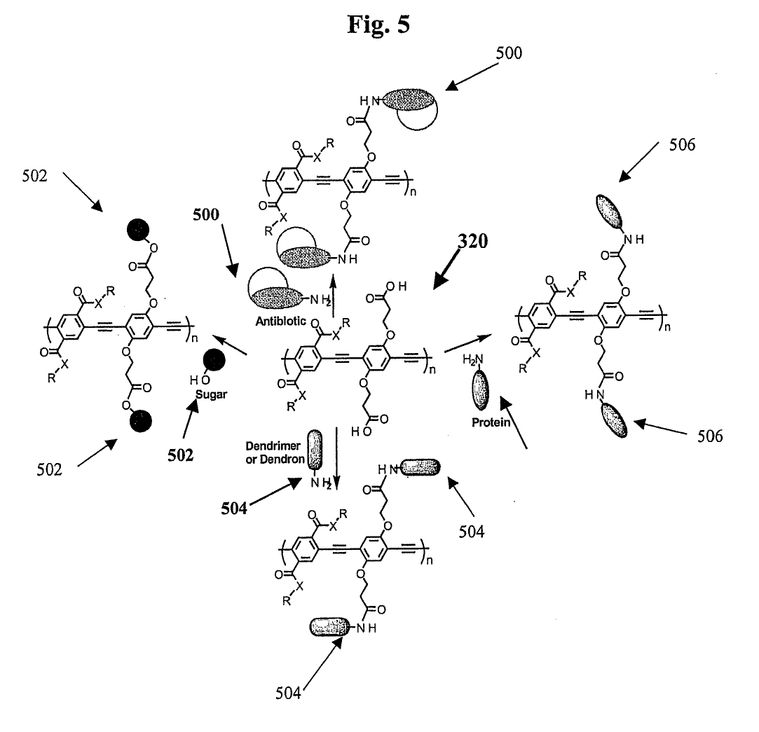

Referring now to structure Pₐ, and the structure of FIG. 2, an example of a PPE polymer platform as disclosed herein is illustrated. As will be described with respect to FIG. 5, the polymer platform Pₐ and polymer platform 220 illustrated in FIG. 2 are also suitable for modifications that provide alternate functionalizations. The polymer platform 220 and polymer platform Pₐ have a backbone comprised of a first characterized monomer portion (222 in FIG. 2) and a second characterized monomer portion (224 in FIG. 2), which form the monomer polymerization unit of the polymer and, as for polymer platform Pₐ, the number “n” of such monomer units ranges from about 20 to about 190. The number of repeating units is determined by proton NMR, for example. The first characterized monomer portion (222 in FIG. 2) and second characterized monomer portion (224 in FIG. 2) are referred to as “first” and “second” merely for the purposes of clarity and it is intended that the positions of the monomers as illustrated in FIG. 2 and in the other figures described herein can be reversed on the polymer backbone.

First monomer portion 222 of FIG. 2 and first monomer portion of Pa comprise a benzene ring that is substituted with Y₁—R₃-Z₃ and Y₂—R₄-Z₄, and Y₁—R₃ and Y₂—R₄, respectively. Second monomer portion 224 of FIG. 2 and second monomer portion of Pₐ comprise a benzene ring that is substituted with X₁—R₁-Z, and X₂—R₂-Z₂, and X₁—R₁ and X₂—R₂, respectively.

First monomer portion of P_{b} comprises a benzene ring that is mono substituted with Y₁—R₃. Second monomer portion of P_{b} comprises a benzene ring that is substituted with X₁—R₁ and X₂—R₂.

First monomer portion of P_{c} comprises a benzene ring that is monosubstituted with Y₂—R₂. Second monomer portion of P_{c} comprises a benzene ring that is monosubstituted with X₁—R₁.

The substituents chosen for Y₁, Y₂, X₁, and X₂ have an effect on the electronic properties of the benzene ring to which they are attached. In particular, the substituents chosen for Y₁, Y₂, X₁, and X₂ will be either electron-withdrawing with respect to the benzene ring or electron-donating with respect to the benzene ring. An electron-withdrawing substitutent leaves the phenyl group electron deficient, therefore such a monomer portion is an electron acceptor. An electron-donating substituent contributes to an electron rich phenyl group, therefore such a monomer portion is an electron donor.

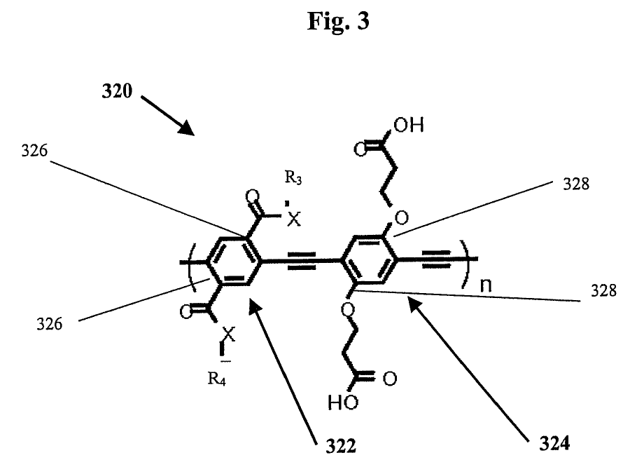

For example, first monomer portion of platform 320 of FIG. 3 and of FIG. 5 is an electron acceptor since the carbonyl group is electron withdrawing. Second monomer portion of platform 320 is an electron donor since the ether group (—O—) is electron donating.

Y₁, Y₂, X₁, and X₂ can be the same or different substituents, and can be CO, COO, CONH, CONHCO, COOCO, CONHCNH, CON, COS, CS, CN, CNN, SO, SO₂, NO, PO (all electron-withdrawing substituents); alkyl (methyl, ethyl, propyl, for example, and up to 10, 20, 30, 40 or 50 carbons), aryl, allyl, N, S, O, or P (all electron-donating groups).

For example, when Y₁, Y₂ X₁, and X₂ are independently COO, the substituent group X_{1or 2}R_{1,2,3 or 4}Z_{1,2,3 or 4} or Y_{1 or 2}R_{1,2,3 or 4}Z_{1,2,3 or 4} may be an acid, ester, anhydride, carbamate, or carbonate, for example; when Y₁, Y₂ X₁, and X₂ are independently CONH, the substituent group X_{1or 2}R_{1,2,3 or 4}Z_{1,2,3 or 4} or Y_{1 or 2}R_{1,2,3 or 4}Z_{1,2,3 or 4} may be an amide or an imide, for example; when Y₁, Y₂ X₁, and X₂ are independently CON, the substituent group X_{1or 2}R_{1,2,3 or 4}Z_{1,2,3 or 4} or Y_{1 or 2}R_{1,2,3 or 4}Z_{1,2,3 or 4} is a mono- or di-substituted amide, for example; when Y₁, Y₂ X₁, and X₂ are independently COS, the substituent group X_{1or 2}R_{1,2,3 or 4}Z_{1,2,3 or 4} or Y_{1 or 2}R_{1,2,3 or 4}Z_{1,2,3 or 4} may be a thioester, thioanhydride, thiocarbamate, or thiocarbonate, for example; when Y₁, Y₂ X₁, and X₂ are independently CS, the substituent group X_{1or 2}R_{1,2,3 or 4}Z_{1,2,3 or 4} or Y_{1 or 2}R_{1,2,3 or 4}Z_{1,2,3 or 4} may be a thioamide or thioimide, for example; when Y₁, Y₂ X₁, and X₂ are independently N, the substituent group X_{1or 2}R_{1,2,3 or 4}Z_{1,2,3 or 4} or Y_{1 or 2}R_{1,2,3 or 4}Z_{1,2,3 or 4} may be an amine, diazo, an imine, a hydrazine, a hydrazone, guanidine, urea, for example; when Y₁, Y₂ X₁, and X₂ are independently NO, the substituent group X_{1 or 2}R_{1,2,3 or 4}Z_{1,2,3 or 4} or Y_{1 or 2}R_{1,2,3 or 4}Z_{1,2,3 or 4} is an N-oxide, for example; when Y₁, Y₂ X₁, and X₂ are independently S, the substituent group X_{1or 2}R_{1,2,3 or 4}Z_{1,2,3 or 4} or Y_{1 or 2}R_{1,2,3 or 4}Z_{1,2,3 or 4} may be a thioether, or thioester, for example; when Y₁, Y₂ X₁, and X₂ are independently O, the substituent group X_{1or 2}R_{1,2,3 or 4}Z_{1,2,3 or 4} or Y_{1 or 2}R_{1,2,3 or 4}Z_{1,2,3 or 4} may be an ether, ester, carbamate, or carbonate, for example; when Y₁, Y₂ X₁, and X₂ are independently CN, the substituent group X_{1or 2}R_{1,2,3 or 4}Z_{1,2,3 or 4} or Y_{1 or 2}R_{1,2,3 or 4}Z_{1,2,3 or 4} may be an imine or a hydrazone, for example; and when Y₁, Y₂ X₁, and X₂ are independently CNN, the substituent group X_{1or 2}R_{1,2,3 or 4}Z_{1,2,3 or 4} or Y_{1 or 2}R_{1,2,3 or 4}Z_{1,2,3 or 4} may be a hydrazone, imide, or carboximidamide, for example. R₁, R₂, R₃ and R₄ can be the same or different substituents, and can be any of a wide variety of groups. In embodiments provided herein, R₁, R₂, R₃ and R₄ are independently alkyl, Z-substituted alkyl, phenyl, Z-substituted phenyl, benzyl, Z-substituted benzyl, aryl, Z-substituted aryl, allyl, Z-substituted allyl or hydrogen.

Substituent Z provides interaction with a host matrix, for example, when the modular polymer of the present invention is used for manufacturing nanocomposites. Substituent Z is also useful for enhancing the dispersion/solubilization of nanomaterials by the modular polymer or for specific interaction or recognition when used with biomolecules. Substituent Z is as defined below.

Substituent Z (i.e., Z₁, Z₂, Z₃ and Z₄, which may be the same or different) comprises any group, or combination of groups, suitable for further manipulation, that is a “manipulation group.” Groups suitable for use as Z₁, Z₂, Z₃ and Z₄ comprise any group that has properties that can be modified.

In further embodiments, substituent Z is independently an acetal, acid halide, acrylate unit, acyl azide, aldehyde, anhydride, cyclic alkene, arene, alkene, alkyne, alkyl halide, aryl, aryl halide, amine, amide, amino, amino acid, alcohol, alkoxy, antibiotic, azide, aziridine, azo compounds, calixarene, carbohydrate, carbonate, carboxylic acid, carboxylate, carbodiimide, cyclodextrin, crown ether, CN, cryptand, dendrimer, dendron, diamine, diaminopyridine, diazonium compounds, DNA, epoxy, ester, ether, epoxide, ethylene glycol, fullerene, glyoxal, halide, hydroxy, imide, imine, imidoester, ketone, nitrile, isothiocyanate, isocyanate, isonitrile, ketone, lactone, ligand for metal complexation, ligand for biomolecule complexation, lipid, maleimide, melamine, metallocene, NHS ester, nitroalkane, nitro compounds, nucleotide, olefin, oligosaccharide, peptide, phenol, phthalocyanine, porphyrin, phosphine, phosphonate, polyamine, polyethoxyalkyl, 2,2′-bipyridine, 1,10-phenanthroline, terpyridine, pyridazine, pyrimidine, purine, pyrazine, 1,8-naphthyridine, polyhedral oligomeric silsequioxane (POSS), pyrazolate, imidazolate, torand, hexapyridine, 4,4′-bipyrimidine, polypropoxyalkyl, protein, pyridine, quaternary ammonium salt, quaternary phosphonium salt, quinone, RNA, Schiff base, selenide, sepulchrate, silane, a styrene unit, sulfide, sulfone, sulfhydryl, sulfonyl chloride, sulfonic acid, sulfonic acid ester, sulfonium salt, sulfoxide, sulfur and selenium compounds, thiol, thioether, thiol acid, thio ester, thymine, or a combination thereof.

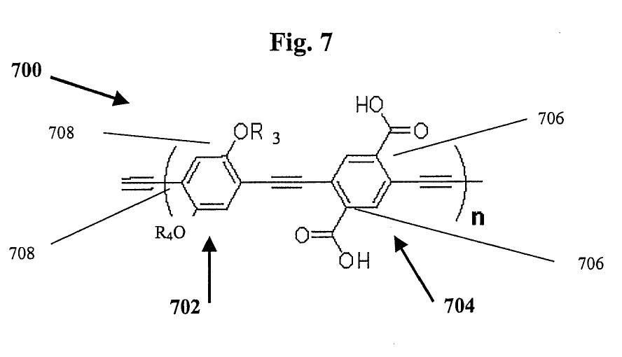

In certain embodiments of the invention, from about 25% to 100% of the polymer has Z groups. In further embodiments of the invention, 10% to about 50% of the Z groups are further functionalized as set forth above to achieve a further peripheral functional group. Such functionalization is useful for affecting dispersion behavior or for enhancing adhesion to composite material, for example. In still other examples considered herein, Z₃ and Z₄ are not present because the groups selected for Y₁, Y₂, R₃ and R₄, or for X₁, X₂, R₁ and R₂, or for Z₁ and Z₂, operate as a manipulation group. One example of a polymer platform where Z₃ and Z₄ are not present will be described with respect to FIG. 3 and FIG. 7. Presence of Z groups is measured by IR, proton NMR, or carbon NMR, for example.

PPE modular polymers for exfoliating and dispersing/solubilizing nanomaterial include those having the structure Pₐ, where X₁R₁═X₂R₂ and Y₁R₃═Y₂R₄; or the structure Pₐ, where X₁═X₂═COO, Y₁═Y₂═O, and R₁-R₄ are independently alkyl, Z-substituted alkyl, phenyl, Z-substituted phenyl, benzyl, Z-substituted benzyl, aryl, Z-substituted aryl, allyl, Z-substituted allyl or hydrogen; or the structure P_{b}, where X₁R₁═X₂R₂; or the structure P_{b}, where X₁═X₂═COO, Y₁═O, and R₁-R₃ are independently alkyl, Z-substituted alkyl, phenyl, Z-substituted phenyl, benzyl, Z-substituted benzyl, aryl, Z-substituted aryl, allyl, Z-substituted allyl or hydrogen; or the structure P_{c}, where X₁═COO, Y₂═O, and R₁-R₂ are independently alkyl, Z-substituted alkyl, phenyl, Z-substituted phenyl, benzyl, Z-substituted benzyl, aryl, Z-substituted aryl, allyl, Z-substituted allyl or hydrogen; or the structure Pₐ, where X₁R₁═X₂R₂═COOH, and Y₁R₃═Y₂R₄═OC₁₀H₂₁; or the structure Pₐ, where X₁R₁═X₂R₂═COOC(CH₃)₃, and Y₁R₃═Y₂R₄═OC₁₀H₂₁; or the structure Pₐ, where X₁R₁═X₂R₂═COO-alkyl, and Y₁R₃═Y₂R₄═OC₁₀H₂₁; or the structure Pₐ, where X₁R₁Z=X₂R₂Z=COO-polyethoxyalkyl, and Y₁R₃═Y₂R₄═OC₁₀H₂₁; or the structure Pₐ, where X₁R₁Z=X₂R₂Z=CONHCH(CH₃)CH₂OCH(CH₃)CH₂Oalkyl, and Y₁R₃═Y₂R₄═OC₁₀H₂₁.

A method of synthesizing a poly(phenyleneethynylene) polymer having a peripheral functional group Z, the method comprising coupling a poly(phenyleneethynylene) polymer Pₐ, P_{b}, or P_{c} as set forth above and a reactant Z to form Z-substituted alkyl, Z-substituted phenyl, Z-substituted benzyl, Z-substituted aryl, or Z-substituted allyl, wherein Z is independently OH, SH, COOH, COOR, CHO, NH₂, CO-alkoxyalkyl, CO-alkylamine, CO-arylamine, CO-alkylhydroxy, CO-arylhydroxy, CO-antibiotic, NH₂-antibiotic, CO-sugar, sugar-OH, CO-dendrimer, CO-dendron, NH₂-dendrimer, NH₂-dendron, CO-protein, NH₂-protein, CO-melamine, CO-epoxy, CO-diamine, CO-alkyl, CO-crown ether, CO-ethylene glycol, CO-polyamine, CO-DNA, CO-RNA, polyethoxyalkyl, polypropoxyalkyl, aziridine group, olefin, NHR, COR, CNR, CN, CONH₂, CONHR, lipid, ligand for metal complexation, ligand for biomolecule complexation, an epoxy group, a styrene unit, an acrylate unit, or a combination thereof, wherein R of COOR is alkyl, aryl, allyl, phenyl, or benzyl.

A further embodiment of the present invention is a composition comprising a poly(phenyleneethynylene) having the structure:

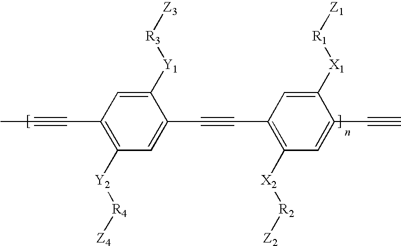

wherein n is from about 20 to about 190; X₁R₁, X₂R₂, Y₁R₃, Y₂R₄, and Y₂R₂ are either electron donating or electron withdrawing substituents; and when X₁R₁ and X₂R₂ are electron donating, then Y₁R₃ and Y₂R₄ are electron withdrawing, and when X₁R₁ and X₂R₂ are electron withdrawing, then Y₁R₃ and Y₂R₄ are electron donating. In this embodiment, X₁, X₂, Y₁, and Y₂ are independently COO, CONH, CONHCO, COOCO, CONHCNH, CON, COS, CS, alkyl, aryl, allyl, N, NO, S, O, SO, CN, CNN, SO₂, P, or PO; R₁-R₄ are independently alkyl, phenyl, benzyl, aryl, allyl, or H; and Z₁-Z₄ are independently an acetal, acid halide, acrylate unit, acyl azide, aldehyde, anhydride, cyclic alkene, arene, alkene, alkyne, alkyl halide, aryl, aryl halide, amine, amide, amino, amino acid, alcohol, alkoxy, antibiotic, azide, aziridine, azo compounds, calixarene, carbohydrate, carbonate, carboxylic acid, carboxylate, carbodiimide, cyclodextrin, crown ether, CN, cryptand, dendrimer, dendron, diamine, diaminopyridine, diazonium compounds, DNA, epoxy, ester, ether, epoxide, ethylene glycol, fullerene, glyoxal, halide, hydroxy, imide, imine, imidoester, ketone, nitrile, isothiocyanate, isocyanate, isonitrile, ketone, lactone, ligand for metal complexation, ligand for biomolecule complexation, lipid, maleimide, melamine, metallocene, NHS ester, nitroalkane, nitro compounds, nucleotide, olefin, oligosaccharide, peptide, phenol, phthalocyanine, porphyrin, phosphine, phosphonate, polyamine, polyethoxyalkyl, 2,2′-bipyridine, 1,10-phenanthroline, terpyridine, pyridazine, pyrimidine, purine, pyrazine, 1,8-naphthyridine, polyhedral oligomeric silsequioxane (POSS), pyrazolate, imidazolate, torand, hexapyridine, 4,4′-bipyrimidine, polypropoxyalkyl, protein, pyridine, quaternary ammonium salt, quaternary phosphonium salt, quinone, RNA, Schiff base, selenide, sepulchrate, silane, a styrene unit, sulfide, sulfone, sulfhydryl, sulfonyl chloride, sulfonic acid, sulfonic acid ester, sulfonium salt, sulfoxide, sulfur and selenium compounds, thiol, thioether, thiol acid, thio ester, thymine, or a combination thereof.

Dispersions/Solutions of Nanomaterial: A method of exfoliating and dispersing nanomaterials using a modular polymer in accordance with certain embodiments of the present invention includes mixing nanomaterial that may or may not have been pre-sonicated; a poly(aryleneethynylene) modular polymer as set forth herein and a dispersion/solubilization solvent to form a dispersion of exfoliated nanomaterial. The term “mixing,” as used herein, means that the nanomaterial and the modular polymer are brought into contact with each other in the presence of the solvent. “Mixing” may include simply vigorous shaking, high shear mixing, mixing at high temperature, mixing under pressure, or may include sonication for a period of time of about 10 min. to about 3 hr.

A dispersion/solubilization solvent may be organic or aqueous such as, for example, chloroform, chlorobenzene, water, acetic acid, acetone, acetonitrile, aniline, benzene, benzonitrile, benzyl alcohol, bromobenzene, bromoform, 1-butanol, 2-butanol, carbon disulfide, carbon tetrachloride, cyclohexane, cyclohexanol, decalin, dibromethane, diethylene glycol, diethylene glycol ethers, diethyl ether, diglyme, dimethoxymethane, N,N-dimethylformamide, ethanol, ethylamine, ethylbenzene, ethylene glycol ethers, ethylene glycol, ethylene oxide, formaldehyde, formic acid, glycerol, heptane, hexane, iodobenzene, mesitylene, methanol, methoxybenzene, methylamine, methylene bromide, methylene chloride, methylpyridine, morpholine, naphthalene, nitrobenzene, nitromethane, octane, pentane, pentyl alcohol, phenol, 1-propanol, 2-propanol, pyridine, pyrrole, pyrrolidine, quinoline, 1,1,2,2-tetrachloroethane, tetrachloroethylene, tetrahydrofuran, tetrahydropyran, tetralin, tetramethylethylenediamine, thiophene, toluene, 1,2,4-trichlorobenzene, 1,1,1-trichloroethane, 1,1,2-trichloroethane, trichloroethylene, triethylamine, triethylene glycol dimethyl ether, 1,3,5-trimethylbenzene, m-xylene, o-xylene, p-xylene, 1,2-dichlorobenzene, 1,3-dichlorobenzene, 1,4-dichlorobenzene, 1,2-dichloroethane, N-methyl-2-pyrrolidone, methyl ethyl ketone, dioxane, or dimethyl sulfoxide. In certain embodiments of the present invention, the dispersion/solubilization solvent is a halogenated organic solvent and, in further embodiments, the dispersion/solubilization solvent is chlorobenzene.

A dispersion/solution of exfoliated nanomaterial comprising nanomaterial as described herein, a modular polymer as described herein and a dispersion/solubilization solvent as described herein is an embodiment of the present invention.

The interaction between modular polymer and nanomaterial in modular polymer-exfoliated and dispersed/solubilized nanomaterial is noncovalent bonding instead of covalent bonding. Therefore, the underlying electronic structure of the nanomaterial and its key attributes are not affected.

The exfoliated nanomaterial may comprise an amount of dispersing/solubilizing modular polymer by weight ratio of greater than zero and less than 1.0; an amount equal to or within a range of any of the following weight ratios: 0.05, 0.10, 0.15, 0.20, 0.25, 0.30, 0.33, 0.35, 0.40, 0.45, 0.50, 0.60, 0.70, 0.80, and 0.90; an amount by weight ratio equal to or greater than 0.15 and less than or equal to 0.50; an amount by weight ratio equal to or greater than 0.20 and less than or equal to 0.35, or an amount by weight ratio of about 0.33.

The exfoliating/dispersing may take place under conditions of acidity or basicity as needed. For example, the MWNT's exfoliated and dispersed by polymers 7 and 8 as provided in Example 3 took place at a pH of 8.0-8.5. The pH of exfoliating/dispersing is dependent upon the nature of polymer substituents, for example, if substituents are acidic in nature, then dispersion is in a basic solvent, if basic in nature, then dispersion is in a neutral or acidic solvent.

Exfoliated nanomaterials dispersed in solvent do not settle out even over a period of weeks. While the nanomaterials can be filtered out on filter paper, this separation is more a function of their large size, not their dispersion or solubility. A sufficiently fine filter can separate most solvated molecules. The terms “dispersion” and “functionalization” are used interchangeably herein.

Dispersion or solubilization is determined using analysis of photographs of an aliquot of the dispersion. A photograph of nanomaterial without dispersing/solubilizing polymers is analyzed as a control. For example, an aliquot (1 mL) of each of a series of nanotube dispersions/solutions having known and increasing concentrations of nanotubes and lacking dispersing/solubilizing polymer is photographed. Nanotubes are dispersed and two different zones are observed: dark zones (aggregates of nanotubes) and clear zones (absence of nanotubes due to the non-dispersion of nanotubes). This series provides a standard reference control. An aliquot (1 mL) of a solution of modular polymer-exfoliated and dispersed/solubilized nanotubes with a known concentration of nanotubes and dispersing/solubilizing polymer is photographed and compared to the control. Highly uniform dispersion is observed in an exfoliated dispersed sample.

Solid Nanomaterial obtained from Dispersion by Removing Solvent: Solid exfoliated nanomaterial is obtained from the dispersions/solutions of exfoliated nanomaterial as described above by removing the solvent by one of many standard procedures well known to those of ordinary skill in the art. Such standard procedures include drying by evaporation such as by evaporation under vacuum or evaporation with heat, casting, precipitation or filtration and the like. A solvent for precipitating solid exfoliated nanomaterials has a polarity that is opposite in the polarity of the polymer backbone side chains. For material obtained by methods of the present invention, the solid material is generally black in color with a uniform network of carbon nanotubes. Solid material may be pulverized to produce a powder.

Removed solvent may be recycled by collection under vacuum and trapping in liquid nitrogen. Such recycled solvent may be used without further purification.

Solid nanomaterial has advantages over dispersions/solutions of nanomaterial such as easier shipping, handling, storage, and a longer shelf life.

Re-dispersed or Re-solubilized Nanomaterial: Solid exfoliated nanomaterial obtained as described above is re-dispersed or re-solubilized by mixing the solid exfoliated nanomaterial with a re-dispersion or re-solubilization solvent. The term “mixing,” as used herein for re-dispersion or re-solubilization, means that the solid exfoliated nanomaterial and the re-dispersion or re-solubilization solvent are brought into contact with each other. “Mixing” for re-solubilization may include simply vigorous shaking, high shear mixing, or may include sonication for a period of time of about 10 min to about 3 h.

The re-dispersion or re-solubilization solvent may be the same solvent as the dispersion or solubilization solvent or may be a different solvent. Accordingly, the re-dispersion solvent may be organic or aqueous such as, for example, chloroform, chlorobenzene, water, acetic acid, acetone, acetonitrile, aniline, benzene, benzonitrile, benzyl alcohol, bromobenzene, bromoform, 1-butanol, 2-butanol, carbon disulfide, carbon tetrachloride, cyclohexane, cyclohexanol, decalin, dibromethane, diethylene glycol, diethylene glycol ethers, diethyl ether, diglyme, dimethoxymethane, N,N-dimethylformamide, ethanol, ethylamine, ethylbenzene, ethylene glycol ethers, ethylene glycol, ethylene oxide, formaldehyde, formic acid, glycerol, heptane, hexane, iodobenzene, mesitylene, methanol, methoxybenzene, methylamine, methylene bromide, methylene chloride, methylpyridine, morpholine, naphthalene, nitrobenzene, nitromethane, octane, pentane, pentyl alcohol, phenol, 1-propanol, 2-propanol, pyridine, pyrrole, pyrrolidine, quinoline, 1,1,2,2-tetrachloroethane, tetrachloroethylene, tetrahydrofuran, tetrahydropyran, tetralin, tetramethylethylenediamine, thiophene, toluene, 1,2,4-trichlorobenzene, 1,1,1-trichloroethane, 1,1,2-trichloroethane, trichloroethylene, triethylamine, triethylene glycol dimethyl ether, 1,3,5-trimethylbenzene, m-xylene, o-xylene, p-xylene, 1,2-dichlorobenzene, 1,3-dichlorobenzene, 1,4-dichlorobenzene, 1,2-dichloroethane, N-methyl-2-pyrrolidone, methyl ethyl ketone, dioxane, or dimethyl sulfoxide. In certain embodiments of the present invention, the re-dispersion solvent is a halogenated organic solvent such as 1,1,2,2-tetrachloroethane, chlorobenzene, chloroform, methylene chloride, or 1,2-dichloroethane and, in further embodiments, the re-dispersion solvent is chlorobenzene.

A dispersion of re-dispersed solid exfoliated nanomaterials comprising solid exfoliated nanomaterial as described herein, and a re-dispersion solvent as described herein is an embodiment of the present invention.

Referring now to FIG. 3, one example of a polymer platform corresponding to the description and illustration of polymer platform 220 in FIG. 2 is illustrated.

Example polymer platform 320, illustrated in FIG. 3, is comprised of a first characterized monomer portion 322 and a second characterized monomer portion 324. In FIG. 3, “n” is as described above with respect to FIG. 2, that is, n is from about 20 to about 190.

In first characterized monomer portion 322, the substituents for Y₁ and Y₂ are selected from the group as described above with respect to FIG. 2, and in particular, Y₁ and Y₂ are one of COO, CONH, and CON (where the X in FIG. 3 is representative of the O, NH or N). The substituents for R₃ and R₄ are also selected from the group as described above with respect to FIG. 2, and in particular, R₃ and R₄ are groups that operate to further disperse nanomaterials.

The Y₁ and Y₂ substituents of the first characterized monomer portion 322 are electron-withdrawing groups, at least in part because of the presence of the carbonyl group (—CO—). The electron-withdrawing characteristic contributes to the generation of an electron-poor area 326 in the benzene ring of the first characterized monomer portion 322. The generation of the electron-poor area 326 in such benzene ring of the first characterized monomer portion 322 causes the portion of the backbone formed by such benzene ring to act as an electron acceptor with respect to materials the polymer platform 320 comes into contact with, such as the nanomaterials described herein.

In the exemplary polymer platform 320, illustrated in FIG. 3, Z₃ and Z₄ are not present, since substituents selected for Z₁ and Z₂ (COOH) on the second characterized monomer portion 324 provide a manipulation group.

Referring now to Z₁ and Z₂ of the second characterized monomer portion 324, Z₁ and Z₂ are selected from the group as described above with respect to FIG. 2, and in particular, Z₁ and Z₂ are COOH. As will be described further with respect to FIG. 5, the presence of COOH as the manipulation group provides a wide variety of manipulation and/or substitution possibilities on the second characterized monomer portion 324. Such manipulation and/or substitution can be performed by merely manipulating the COOH group of Z₁ and Z₂, while other groups on the backbone can be left untouched. In addition, such manipulation and/or substitution can be performed after polymerization of the polymer platform.

Still referring to the second characterized monomer portion 324 illustrated in FIG. 3, the substituents for X₁ and X₂ are selected from the group as described above with respect to FIG. 2, and in particular, X₁ and X₂ are O. The substituents for R₁ and R₂ are also selected from the group as described above with respect to FIG. 2, and in particular, R₁ and R₂ are CH₂—CH₂. In contrast to the electron-poor area 326 generated in the first characterized monomer portion 322, an electron-rich area 328 is generated on the second characterized monomer portion 324. The generation of the electron-rich area 328 is caused at least in part because the substituents for X₁ and X₂ are electron-donating with respect to the benzene ring to which X₁ and X₂ are attached. The generation of the electron-rich area 328 in such benzene ring of the second characterized monomer portion 324 causes the portion of the backbone formed by such benzene ring to act as an electron donor with respect to materials the polymer platform 320 comes into contact with, such as the nanomaterials described herein.

The electron-donor/electron-acceptor characteristic of the backbone of polymer platform 320 is particularly useful in exfoliation of nanomaterials. For example, when the nanomaterials are carbon nanotubes, the carbon nanotubes are typically bundled or roped, which bundles or ropes must be undone at least in part, i.e., exfoliated, to enable the dispersion/solubilization and functionalization of the nanotubes. In particular, a polymer platform such as polymer platform 320 exfoliates carbon nanotubes with such efficacy that the carbon nanotubes are solubilized without requiring a pre-sonication step. Any degree of exfoliation or “unbundling” of nanomaterial means “exfoliation,” as used herein. A degree of exfoliation is measured by the ability to disperse material, by viscosity of the system, or electrical conductivity as compared to a control.

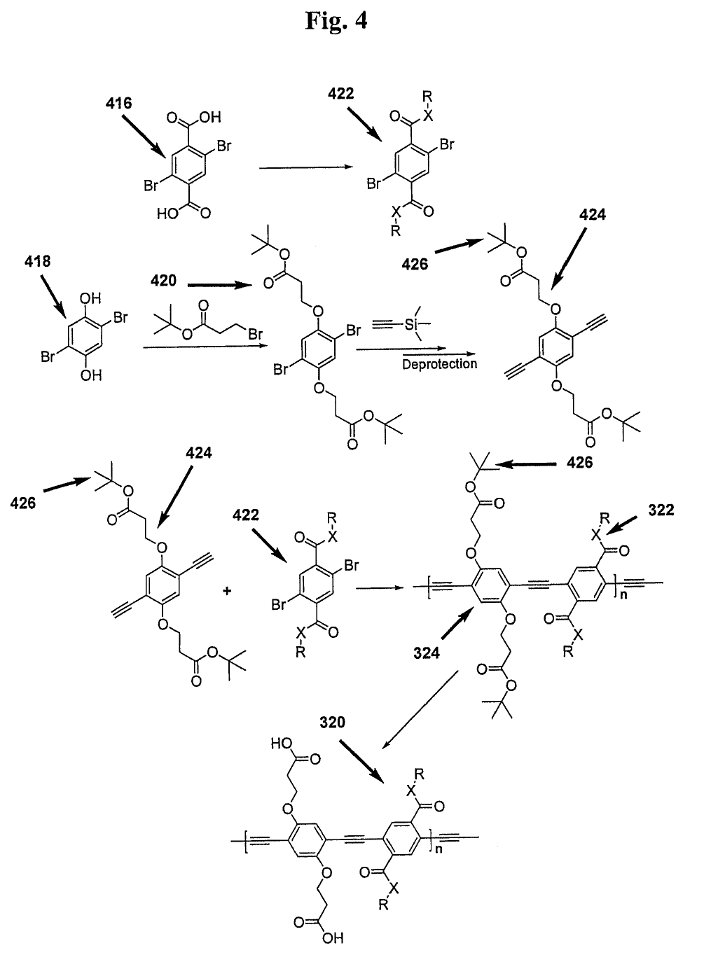

Referring now to FIG. 4, the synthesis of a polymer platform such as that illustrated in FIG. 3 is illustrated. A terephthalic acid starting material 416 is reacted according to the reaction conditions described below with respect to the synthesis of the second characterized monomer portion 1004 illustrated in FIG. 10 to form a first characterized precursor monomer 422. A dibromo-dihydroxy starting material 418 is reacted with t-butyl bromopropionate to form intermediate material 420 which, according to techniques known to those of ordinary skill in the art is coupled using the Sonogashira reaction (Tetrahedron Lett. 1975, 4467) and deprotected to form a second characterized precursor monomer 424. Second characterized precursor monomer 424 and first characterized precursor monomer 422 are then polymerized according to known methods (see Bunz, Chem. Rev. 2000, 100:1605-1644) to result in a modular polymer platform comprising a first characterized monomer portion 322 and a second characterized monomer portion 324, such as described with respect to FIG. 3.

In the synthesis illustrated in FIG. 4, a capping group 426 is present on the carboxyl group (COOH) terminating the Z₁ and Z₂ substituents of the second characterized precursor monomer 424 during and subsequent to reaction with first characterized precursor monomer 422, which capping group 426 can be subsequently removed by any of a variety of methods suitable to substitute a hydrogen atom for the capping group. One such method is described with respect to the synthesis of the polymer platform 1000 illustrated in FIG. 10. Removal of the capping group 426 results in a polymer platform such as described with respect to FIG. 3. In examples where the Z₁ and Z₂ substituents of the second characterized precursor monomer 424 are other than COOH, such as an amine (NH₂), hydroxyl (OH) or thiol (SH), a capping group is preferably not present on Z₁ and Z₂.

Once a polymer comprised of “n” number of polymer platforms, such as polymer platform 220 illustrated in FIG. 2, has been prepared, the polymer can be mixed with nanomaterials, such as carbon nanotubes, to cause, depending on the substituents selected for each X, Y, R and Z, exfoliation and dispersion/solubilization/functionalization of the nanomaterials. In certain examples, one or more of the Z substituents comprise manipulation groups that enable a wide variety of further manipulation and/or substitution on the monomer portion carrying the manipulation group. As described above, one or more manipulation groups can be placed on either the first characterized monomer portion 222 or the second characterized monomer portion 224 of the polymer platform 220. According to one exemplary polymer, where a polymer platform such as the example polymer platform 320 illustrated in FIG. 3 has been polymerized, it is the second characterized monomer portion that has Z groups that comprise a manipulation group. An example of manipulations that can be performed with a polymer polymerized from a platform such as polymer platform 320 will now be described with respect to FIG. 5.

Four possible manipulations of Z₁ and Z₂ of the second monomer portion are illustrated in FIG. 5. Z₁ and Z₂ comprise COOH in the example of FIG. 5, however, it is again repeated that Z₁ and Z₂ can be any group that has properties that can be modified, such as those cited herein above. In the example illustrated in FIG. 5, Z₁ and Z₂ are manipulated such that the hydroxyl (OH) group is removed from the carboxylic acid group (COOH), and is replaced with a replacement group, such as an antibiotic 500, a sugar 502, a dendrimer or dendron 504 or a protein 506. In another example, the hydroxyl (OH) groups are removed from the carboxylic acid groups (COOH), and replaced with replacement groups that comprise melamine groups. In such an example, the hydrogens of the melamine groups are useful for hydrogen bonding, which results in a melamine-substituted polymer forming a “chemically aligned” network upon association with nanomaterials, such as carbon nanotubes. The first monomer portion of FIG. 5 is an electron acceptor due to the electron withdrawal property of —COXR. Here, X comprises O, NH, N, S, NHCO, OCO, or NHCNH, for example, and R comprises a group as set forth above for R₁, R₂, R₃, or R₄.

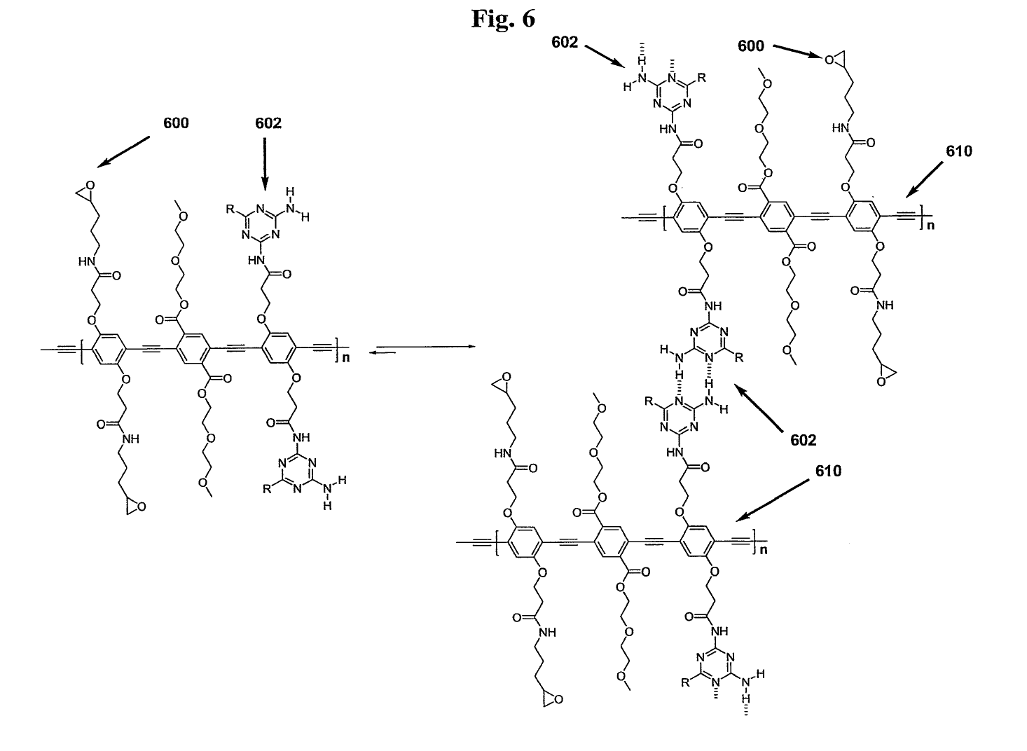

Other examples of manipulations of Z₁ and Z₂ that can be made after polymerization of the polymer platform 320 include but are not limited to replacement of the hydroxyl group with one or more replacement groups such as an epoxy group, a diamine, an alkyl group, crown ether, ethylene glycol, polyamine, polymer units, or any combination of such, including antibiotics, sugars, dendrimers, DNA, RNA and proteins as described above. One example of such a combination is illustrated in FIG. 6.

In FIG. 6, epoxy groups 600 and melamine groups 602 are selected as replacement groups. The replacement groups will be statistically placed on the side chains of the polymer that terminate in manipulation groups, such as when Z₁ and Z₂ are COOH. Polymers 610 will then chemically align due to hydrogen bonding between the melamine groups 602, while the epoxy groups 600 are useful for enhancing adhesion to an epoxy matrix. Nanomaterials associated with such a polymer 610, such as by mixing the nanomaterials with the polymer 610 in a solvent, such as chloroform, will therefore experience alignment and enhanced adhesion to an epoxy matrix.

Referring now to FIG. 7, another example of a polymer platform corresponding to the description and illustration of polymer platform 220 in FIG. 2 is illustrated. Polymer platform 700 illustrated in FIG. 7 is also suitable for any and all of the modifications as described with respect to FIG. 5 and FIG. 6.

Example polymer platform 700, illustrated in FIG. 7, is comprised of a first characterized portion 702 and a second characterized monomer portion 704. In FIG. 7, “n” is as described above with respect to FIG. 2, that is, n ranges from about 20 to about 190.

In first characterized monomer portion 702, the substituents for Y₁ and Y₂ are selected from the group as described above with respect to FIG. 2, and in particular, Y₁ and Y₂ are O. The substituents for R₃ and R₄ are also selected from the group as described above with respect to FIG. 2, and in particular, R₃ and R₄ are groups that operate to solubilize nanomaterials, such as alkyl, aryl, and allyl.

Polymer platform 700 also illustrates that when Y₁, Y₂ and X₁, X₂ are either electron-withdrawing or electron-donating, such groups can be placed on either the first characterized monomer portion 702 or the second characterized monomer portion 704. In polymer platform 700, an electron-rich area 708 is present on the first characterized monomer portion 702. The presence of the electron-rich area 708 is caused at least in part because the substituents for Y₁ and Y₂ are electron-donating with respect to the benzene ring to which Y₁ and Y₂ are attached. The presence of the electron-rich area 708 in such benzene ring of the first characterized monomer portion 702 causes the portion of the backbone formed by such benzene ring to act as an electron donor with respect to materials the polymer platform 700 comes into contact with, such as the nanomaterials described herein.

In the exemplary polymer platform 700, illustrated in FIG. 7, Z₃ and Z₄ are not present since the substituents selected for X₁, X₂, R₁ and R₂, on the second characterized monomer portion 704, provide a manipulation group.

The substituents selected for X₁ and X₂ on the second characterized monomer portion 704 are selected from the group as described above with respect to FIG. 2, and in particular, X₁ and X₂ are COO. The substituents for R₁ and R₂ are also selected from the group as described above with respect to FIG. 2, and in particular, R₁ and R₂ are H. Because X₁, X₂, R₁ and R₂ provide a manipulation group as described above with respect to FIG. 2, and in particular, X₁, X₂, R₁ and R₂ provide COOH, Z₁ and Z₂ are not necessary. The presence of a manipulation group provided by X₁, X₂, R₁ and R₂ such as COOH in exemplary platform polymer 700, provides a wide variety of manipulation and/or substitution possibilities on the second characterized monomer portion 704. Such manipulations and/or substitutions can be performed by merely manipulating the manipulation group, while other groups on the backbone can be left untouched. In addition, such manipulation and/or substitution can be performed after polymerization of the polymer platform.

The X₁ and X₂ substituents of the second characterized monomer portion 704 are electron-withdrawing groups, at least in part because of the presence of the carbonyl group (—CO—). The electron-withdrawing characteristic contributes to the generation of an electron-poor area 706 in the benzene ring of the second characterized monomer portion 704. The generation of the electron-poor area 706 in such benzene ring of the second characterized monomer portion 704 causes the portion of the backbone formed by such benzene ring to act as an electron acceptor with respect to materials the polymer platform 700 comes into contact with, such as the nanomaterials described herein.

The electron-donor/electron-acceptor characteristic of the backbone of polymer platform 700 is particularly useful in exfoliation of nanomaterials. For example, when the nanomaterials are carbon nanotubes, the carbon nanotubes are typically bundled or roped, which bundles or ropes must be undone at least in part, i.e., exfoliated, to enable the solubilization and functionalization of the nanotubes. In particular, a polymer platform such as polymer platform 700 exfoliates carbon nanotubes with such efficacy that the carbon nanotubes are solubilized without requiring a pre-sonication step.

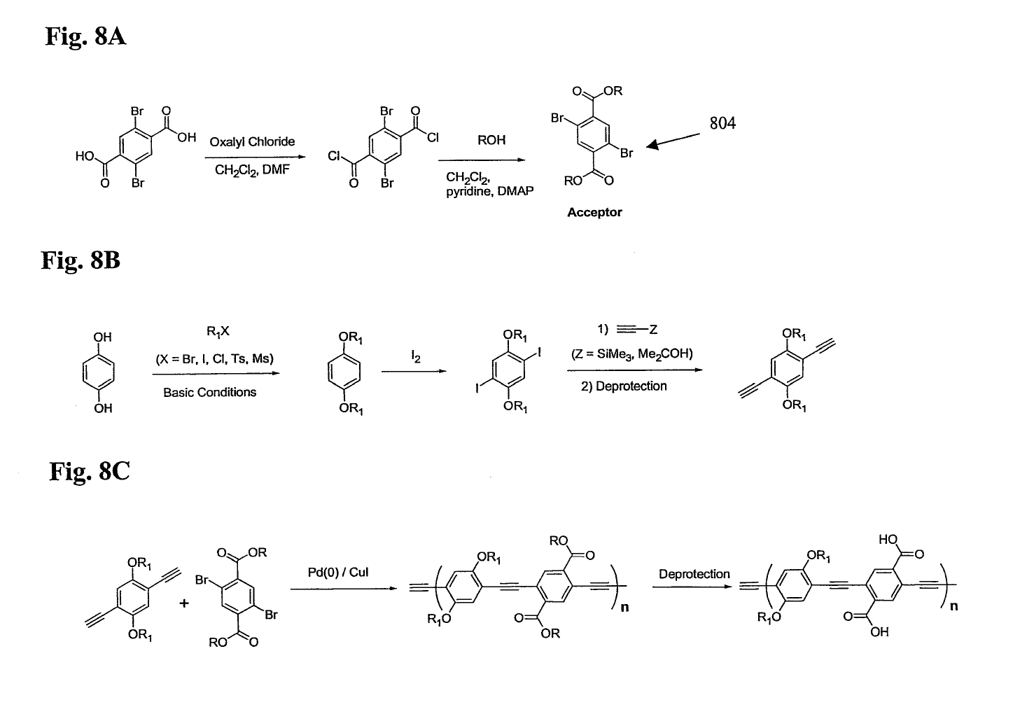

Referring now to FIG. 8, the synthesis of a polymer platform such as that illustrated in FIG. 7 is illustrated. The synthesis is as set forth in FIG. 8, in which it is noted that monomer portion 804 is coupled with monomer portion 702 during polymerization. The coupling reaction is known, for example, from Shultz, et al., (J. Org. Chem. 1998:63, 4034-4038, 1998), Moroni, et al., (Macromolecules 1997, 30, 1964-1972), Zhou and Swager (J. Am. Chem. Soc. 1995, 117, 12593-12602), and Bunz, (Chem. Rev. 2000, 100:1605-1644). Each reference is incorporated by reference herein in their entirety. Catalysts for polymerization include palladium species that readily move between oxidation states of 0 and +2, such as palladium chloride in the presence of triphenylphosphine, tetrakis palladium and palladium acetate, for example.

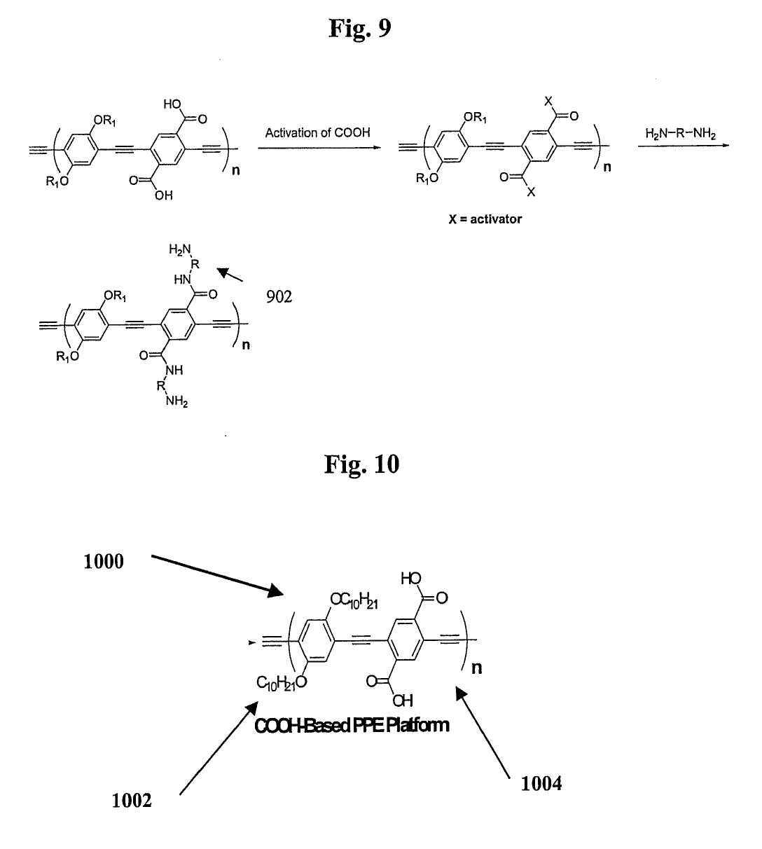

As stated above, polymer platform 700 illustrated in FIG. 7 is suitable for any and all of the modifications as described with respect to FIG. 5 and FIG. 6. A particular modification of exemplary polymer platform 700 is illustrated in FIG. 9, in which the hydroxyl groups of the COOH groups provided by X₁, X₂, R₁ and R₂, are replaced with a diamine group, where R is a group such as alkyl, aryl, and allyl. As with other modifications illustrated herein, the modification illustrated in FIG. 9 can be performed after polymerization of the polymer platform 700, and either before or after association with nanomaterials.

Referring now to FIG. 10, yet another exemplary polymer platform such as that illustrated in FIG. 7 is illustrated. In particular, polymer platform 1000 in FIG. 10 is the polymer platform 700 described in FIG. 7, where R₃ and R₄ are specified in FIG. 10 as C₁₀H₂₁.

Product-by-Process: Polymers, exfoliated nanomaterial, dispersions/solutions of such exfoliated nanomaterial, solids of exfoliated nanomaterials, and re-dispersed dispersions of exfoliated nanomaterial made by a method of the present invention are embodiments of the present invention. For example, a poly(aryleneethynylene) polymer made by methods described herein, a dispersion/solution thereof made by methods as described herein, and a solid material made therefrom by methods described herein are embodiments of the present invention.

Composites of Exfoliated/Dispersed Nanomaterial: Composites of exfoliated nanomaterial as provided herein dispersed within a host matrix are embodiments of the present invention. The host matrix may be a host polymer matrix or a host nonpolymer matrix as described in U.S. patent application Ser. No. 10/850,721 filed May 21, 2004, the entire contents of which is incorporated by reference herein.

The term “host polymer matrix,” as used herein, means a polymer matrix within which the exfoliated nanomaterial is dispersed. A host polymer matrix may be an organic polymer matrix or an inorganic polymer matrix, or a combination thereof.

Examples of a host polymer matrix include a nylon, polyethylene, epoxy resin, polyisoprene, sbs rubber, polydicyclopentadiene, polytetrafluoroethulene, poly(phenylene sulfide), poly(phenylene oxide), silicone, polyketone, aramid, cellulose, polyimide, rayon, poly(methyl methacrylate), poly(vinylidene chloride), poly(vinylidene fluoride), carbon fiber, polyurethane, polycarbonate, polyisobutylene, polychloroprene, polybutadiene, polypropylene, poly(vinyl chloride), poly(ether sulfone), poly(vinyl acetate), polystyrene, polyester, polyvinylpyrrolidone, polycyanoacrylate, polyacrylonitrile, polyamide, poly(aryleneethynylene), poly(phenyleneethynylene), polythiophene, thermoplastic, thermoplastic polyester resin (such as polyethylene terephthalate), thermoset resin (e.g., thermosetting polyester resin or an epoxy resin), polyaniline, polypyrrole, or polyphenylene such as PARMAX®, for example, other conjugated polymers (e.g., conducting polymers), or a combination thereof.

Further examples of a host polymer matrix includes a thermoplastic, such as ethylene vinyl alcohol, a fluoroplastic such as polytetrafluoroethylene, fluoroethylene propylene, perfluoroalkoxyalkane, chlorotrifluoroethylene, ethylene chlorotrifluoroethylene, or ethylene tetrafluoroethylene, ionomer, polyacrylate, polybutadiene, polybutylene, polyethylene, polyethylenechlorinates, polymethylpentene, polypropylene, polystyrene, polyvinylchloride, polyvinylidene chloride, polyamide, polyamide-imide, polyaryletherketone, polycarbonate, polyketone, polyester, polyetheretherketone, polyetherimide, polyethersulfone, polyimide, polyphenylene oxide, polyphenylene sulfide, polyphthalamide, polysulfone, or polyurethane. In certain embodiments, the host polymer includes a thermoset, such as allyl resin, melamine formaldehyde, phenol-fomaldehyde plastic, polyester, polyimide, epoxy, polyurethane, or a combination thereof.

Examples of inorganic host polymers include a silicone, polysilane, polycarbosilane, polygermane, polystannane, a polyphosphazene, or a combination thereof.

More than one host matrix may be present in a nanocomposite. By using more than one host matrix, mechanical, thermal, chemical, or electrical properties of a single host matrix nanocomposite are optimized by adding exfoliated nanomaterial to the matrix of the nanocomposite material. For example, addition of polycarbonate in addition to epoxy appears to reduce voids in a nanocomposite film as compared to a nanocomposite film with just epoxy as the host polymer. Such voids degrade the performance of nanocomposites.

In one embodiment, using two host polymers is designed for solvent cast epoxy nanocomposites where the exfoliated nanomaterial, the epoxy resin and hardener, and the polycarbonate are dissolved in solvents and the nanocomposite film is formed by solution casting or spin coating.

Host nonpolymer matrix: The term “host nonpolymer matrix,” as used herein, means a nonpolymer matrix within which the nanomaterial is dispersed. Examples of host nonpolymer matrices include a ceramic matrix (such as silicon carbide, boron carbide, or boron nitride), or a metal matrix (such as aluminum, titanium, iron, or copper), or a combination thereof. Exfoliated nanomaterial is mixed with, for example, polycarbosilane in organic solvents, and then the solvents are removed to form a solid (film, fiber, or powder). The resulting nanocomposite is further converted to SWNTs/SiC nanocomposite by heating at 900-1600° C. either under vacuum or under inert atmosphere (such as Ar).

A further embodiment of the invention is the above-cited nanocomposite wherein the exfoliated nanomaterial of the nanocomposite is a primary filler and the nanocomposite further comprises a secondary filler to form a multifunctional nanocomposite. In this embodiment, the secondary filler comprises a continuous fiber, a discontinuous fiber, a nanoparticle, a microparticle, a macroparticle, or a combination thereof. In another embodiment, the exfoliated nanomaterial of the nanocomposite is a secondary filler and the continuous fiber, discontinuous fiber, nanoparticle, microparticle, macroparticle, or combination thereof, is a primary filler.

Multifunctional nanocomposites: Nanocomposites can themselves be used as a host matrix for a secondary filler to form a multifunctional nanocomposite. Examples of a secondary filler include: continuous fibers (such as carbon fibers, carbon nanotube fibers, carbon black (various grades), carbon rods, carbon nanotube nanocomposite fibers, KEVLAR® fibers, ZYLON® fibers, SPECTRA® fibers, nylon fibers, VECTRAN® fibers, Dyneema Fibers, glass fibers, or a combination thereof, for example), discontinuous fibers (such as carbon fibers, carbon nanotube fibers, carbon nanotube nanocomposite fibers, KEVLAR® fibers, ZYLON® fibers, SPECTRA® fibers, nylon fibers, or a combination thereof, for example), nanoparticles (such as metallic particles, polymeric particles, ceramic particles, nanoclays, diamond particles, or a combination thereof, for example), and microparticles (such as metallic particles, polymeric particles, ceramic particles, clays, diamond particles, or a combination thereof, for example). In a further embodiment, the continuous fiber, discontinuous fiber, nanoparticle, microparticle, macroparticle, or combination thereof, is a primary filler and the exfoliated nanomaterial is a secondary filler.

A number of existing materials use continuous fibers, such as carbon fibers, in a matrix. These fibers are much larger than carbon nanotubes. Adding exfoliated nanomaterial to the matrix of a continuous fiber reinforced nanocomposite results in a multifunctional nanocomposite material having improved properties such as improved impact resistance, reduced thermal stress, reduced microcracking, reduced coefficient of thermal expansion, or increased transverse or through-thickness thermal conductivity. Resulting advantages of multifunctional nanocomposite structures include improved durability, improved dimensional stability, elimination of leakage in cryogenic fuel tanks or pressure vessels, improved through-thickness or inplane thermal conductivity, increased grounding or electromagnetic interference (EMI) shielding, increased flywheel energy storage, or tailored radio frequency signature (Stealth), for example. Improved thermal conductivity also could reduce infrared (IR) signature. Nanocomposites as provided herein are also useful for flame retardant materials, materials with improved optical properties, materials for x-ray shielding, materials for anti-microbial uses, materials for chemical/environmental resistance, and materials for sensing. Further existing materials that demonstrate improved properties by adding exfoliated nanomaterial include metal particle nanocomposites for electrical or thermal conductivity, nano-clay nanocomposites, or diamond particle nanocomposites, for example.

Articles of manufacture: An article of manufacture comprising a modular polymer, a dispersion, a solid, or a re-dispersed solid as set forth herein is an embodiment of the present invention. Such articles of manufacture include, for example, epoxy and engineering plastic composites, filters, actuators, adhesive composites, elastomer composites, materials for thermal management (interface materials, spacecraft radiators, avionic enclosures and printed circuit board thermal planes, materials for heat transfer applications, such as coatings, for example), aircraft, ship infrastructure and automotive structures, improved dimensionally stable structures for spacecraft and sensors, materials for ballistic applications such as panels for air, sea, and land vehicle protection, body armor, protective vests, and helmet protection, tear and wear resistant materials for use in parachutes, for example, reusable launch vehicle cryogenic fuel tanks and unlined pressure vessels, fuel lines, packaging of electronic, optoelectronic or microelectromechanical components or subsystems, rapid prototyping materials, fuel cells, medical materials, composite fibers, improved flywheels for energy storage, sporting and consumer goods, O-rings, gaskets, or seals, for example.

The following examples are presented to further illustrate various aspects of the present invention, and are not intended to limit the scope of the invention.

### Example 1

### Synthesis of a Donor/Acceptor PPE Platform

The synthesis of polymer platform 1000 of FIG. 10 will now be described in the following paragraphs. Polymer platform 1000 is an example of a polymer having “n” monomer units, each monomer unit having one acceptor monomer portion and one donor monomer portion.

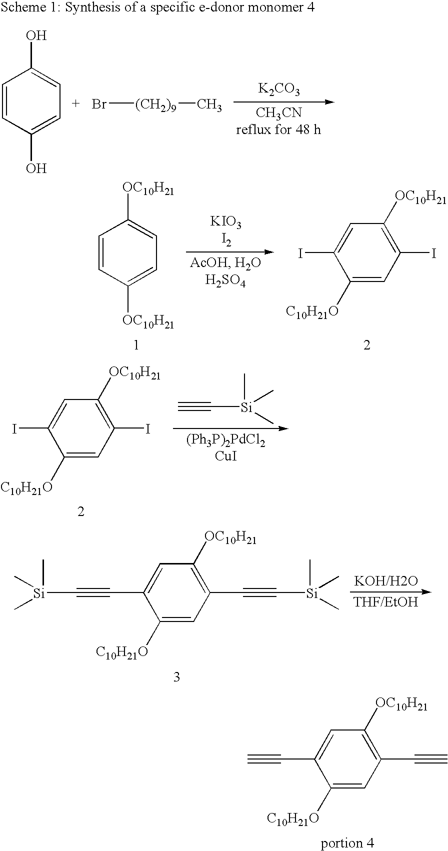

In this Scheme 1, monomer portion 4 comprises the first characterized monomer portion 1002 illustrated in FIG. 10. Preparation of 1, 2 and 3 is now described.

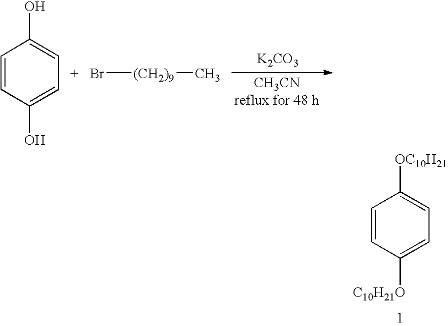

1,4-didecyloxybenzene (1): A 1-L, three-necked flask, equipped with a reflux condenser and mechanical stirrer is charged under argon atmosphere with 1,4-hydroquinone (44.044 g, 0.4 mol) and potassium carbonate, K₂CO₃, (164.84 g, 1.2 mol), and acetonitrile (ACS grade, 500 mL). 1-Bromodecane (208.7 mL, 1.0 mol) was added and the reaction mixture was then heated to reflux under argon flow for 48 h. The hot solution was poured into an Erlenmeyer flask charged with water (1.5 L) and stirred with a magnetic bar stirrer to precipitate the product. The beige precipitate was then collected by filtration using a Buchner funnel with a fritted disc, washed with water (1.0 L), dried, and then dissolved in hot hexanes (ACS grade, 250 mL). The resulting hot hexanes solution was added slowly into an Erlenmeyer flask charged with ethanol (tech. grade, 1.5 L) and vigorously stirred to precipitate the product. The mixture was stirred for at least 2 h then the white precipitate was collected by filtration on a Buchner funnel equipped with a fritted disc, washed with cooled ethanol (tech. grade, 0.5 L), and dried under vacuum pressure for 12 h to give 151.5 g (97% yield) of a fluffy white solid. ¹H NMR (CDCl₃) δ 6.83 (s, 4H), 3.92 (t, J=6.6 Hz, 4H), 1.73 (m, 4H), 1.45 (m, 4H), 1.30 (m, 22H), 0.91 (t, J=6.7 Hz, 6H).

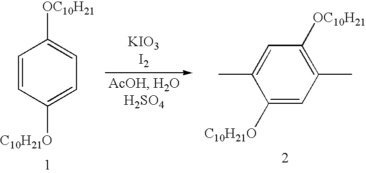

1,4-didecyloxy-2,5-diiodobenzene (2): A 1-L, two-necked flask equipped with a reflux condenser, and magnetic bar stirring was charged with potassium iodate, KIO₃, (15.20 g, 0.066 mol), iodine (36.90 g, 0.132 mol), acetic acid (700 mL), water (50 mL), and sulfuric acid (15 mL). 1,4-didecyloxybenzene (1) (51.53 g, 0.132 mol) was added to the solution and the reaction mixture was then heated to reflux for 8 hours. The purple solution was allowed to cool down to room temperature under constant agitation and saturated aqueous solution of sodium thiosulphate (100 mL) was added until the brown iodine color was gone. The beige-brown precipitate was collected by filtration using a Buchner funnel equipped with a fritted disc, washed with water (700 mL), ethanol (500 mL), and dried. This solid was then dissolved in hot hexanes (300 mL). The resulting hot hexanes solution was poured slowly into an Erlenmeyer flask charged with ethanol (1.5 L) and vigorously stirred to give a white precipitate. This precipitate was collected by filtration, washed with ethanol (1.0 L), and dried under vacuum overnight to give 78.10 g (92% yield) of pure white solid. ¹H NMR (CDCl₃) δ 7.21 (s, Ph, 2H), 3.94 (t, J=6.4 Hz, OCH₂, 4H), 1.82 (m, CH₂, 4H), 1.47 (m, CH₂, 4H), 1.29 (m, CH₂, 22H), 0.90 (t, J=6.72 Hz, CH₃, 6H). 13C NMR (CDCl₃) d 152.8, 122.7, 86.2, 70.3, 31.9, 29.5, 29.3, 29.2, 29.1, 26.0, 22.6, 14.1.

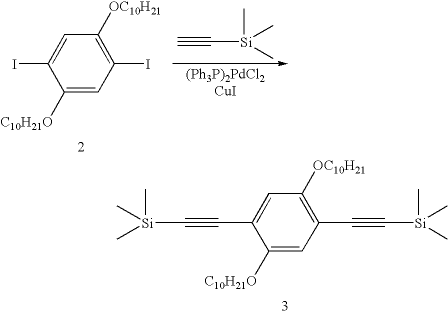

1,4-didecyloxy-2,5-bis-(trimethylsilylethynyl)benzene (3): To a degassed 1.5 L of diisopropylamine was added 1,4-didecyloxy-2,5-diiodobenzene (2) intermediate (100.0 g, 0.1557 mol), CuI (1.48 g, 0.00778 mol), dichlorobis(triphenylphosphine)palladium(II) (5.46 g, 0.00778 mol). The reaction mixture was stirred for 10 minutes and trimethylsilylacetylene (48.4 mL, 0.342 mol) was added slowly over 15-30 minutes at room temperature. The diisopropylammonium salts are formed during the addition and at the end of the addition the solution turned dark brown. After the addition was completed, the reaction mixture was stirred at reflux for 8 h. After cooling, the mixture was diluted with hexanes (500 mL) and filtered through a 4 cm plug of silica gel. The solvent was removed and the product was precipitated from chloroform/EtOH (1:5, 1.5 L). The solid was filtered, washed with water (250 mL), washed with EtOH (250 mL) and dried to give 81.8 g of the desired product as a white solid. Yield (91%). ¹H NMR (CDCl₃) δ 6.85 (s, Ph, 2H), 3.93 (t, J=6.4 Hz, OCH₂, 4H), 1.78 (m, CH₂, 4H), 1.27 (m, CH₂, 22H), 0.88 (t, J=6.42 Hz, CH₃, 6H), 0.26 (s, 18H). 13C NMR (CDCl3) d 154.0, 117.2, 113.9, 101.0, 100.0, 69.4, 31.9, 29.6, 29.5, 29.4, 29.3, 26.0, 22.6, 14.1, 0.17.

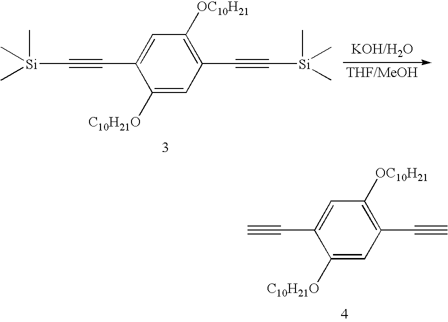

1,4-Diethynyl-2,5-didecyloxybenzene (4): 200 mL of methanol and 120 mL of 20% KOH were added to a rapidly stirred solution of 1,4-didecyloxy-2,5-bis(trimethylsilylethynyl)benzene (80.0 g, 137.21 mmol) in THF (500 mL) at room temperature. The reaction mixture was stirred overnight. The THF was then removed under reduced pressure and the residue was diluted with EtOH (400 mL). A pale yellow solid was filtered, washed with EtOH (250 mL), and dried to give 60.05 g of the desired pale yellow product. Yield (99.7%). ¹H NMR (CDCl₃) δ 6.96 (s, Ph, 2H), 3.98 (t, J=6.58 Hz, OCH₂, 4H), 3.34 (s, CCH, 2H), 1.82 (m, CH₂, 4H), 1.52 (m, CH₂, 4H), 1.31 (m, CH₂, 22H), 0.88 (t, J=6.71 Hz, CH₃, 6H). ¹³C NMR (CDCl₃) d 153.9, 117.7, 113.2, 82.4, 79.7, 69.6, 31.9, 29.5, 29.3, 29.1, 25.9, 22.6, 14.1.

The synthesis of second characterized monomer portion 1004 illustrated in FIG. 10 will now be described.

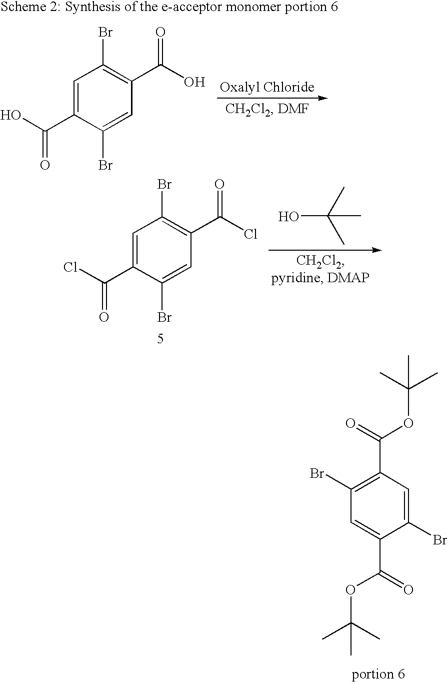

In this Scheme 2, preparation of (5) and (6) is now described.

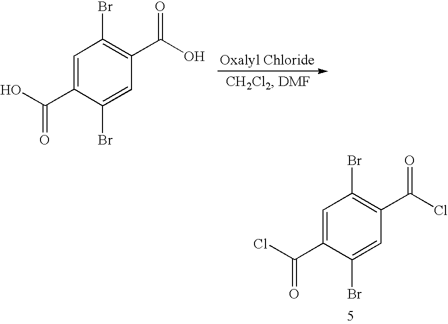

Dibromo diacid chloride (5): Oxalyl chloride (108.6 mL, 1.244 mol) was added slowly at room temperature and under argon flow to a suspension of dibromo acid (168.0 g, 0.518 mol) in dichloromethane. A few drops of dry DMF were added and the reaction mixture was stirred for 10 minutes then heated to reflux for 12 h. ½ of dichloromethane was removed under pressure and hexanes (500 mL) was added. The pale yellow precipitate was recovered by filtration, washed with hexanes (250 mL) and dried under vacuum overnight to give 185.00 g (98.8% yield).

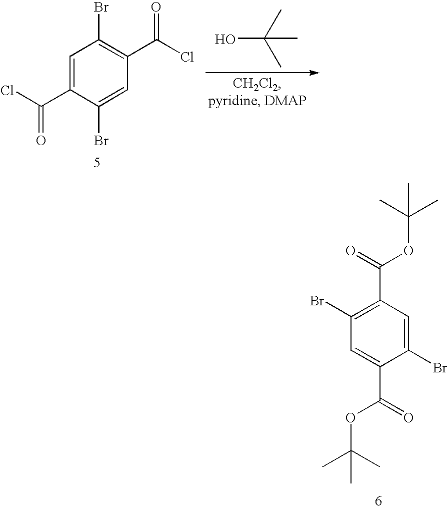

Diester monomer (6): A solution of diacid chloride (10.0 g, 272.72 mmol) in THF (25 mL) was added over 45 minutes to a solution of tert-butanol (10.60 mL, 110.9 mmol), and pyridine (110.9 mmol) in dichloromethane (100 mL) at 5° C. and under argon. The reaction mixture was then allowed to warm to room temperature and stirred overnight under argon. The reaction mixture was concentrated using a rotary evaporator and the residue was diluted with a mixture of H₂O/MeOH (1:1; 100 mL). The white precipitate was filtered, washed with 1.8 N KOH solutions (100 mL), washed with cooled water-methanol mixture (100 mL), and then dried under vacuum overnight to give 9.2 g of the desired product (yield 76%).

An exemplary polymerization of the monomer portions will now be described.

### Example of PPE Polymerization:

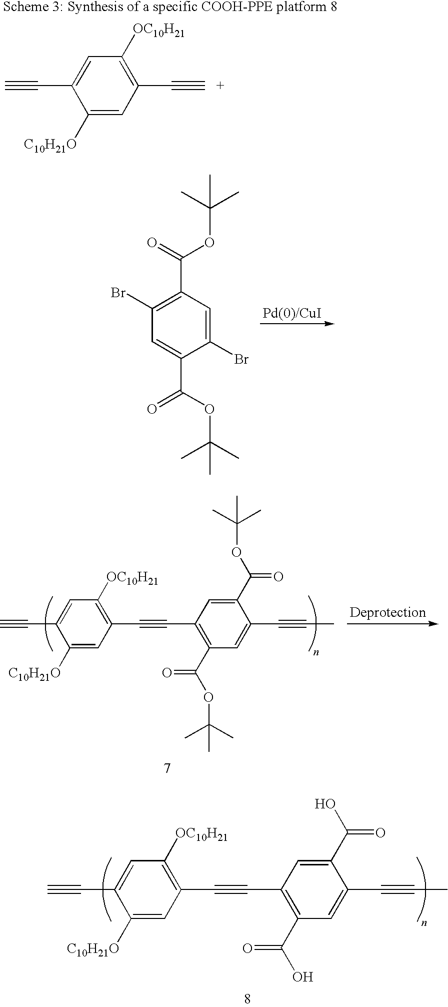

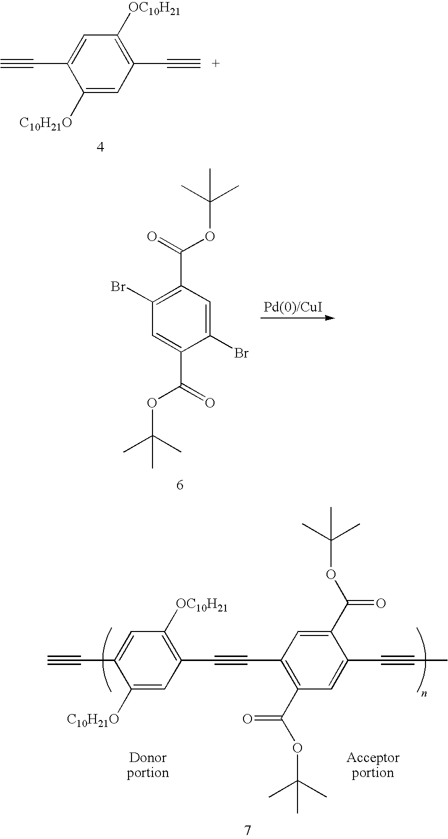

Donor/Acceptor based PPE (7): A 100-mL, oven dried two-necked flask, equipped with a reflux condenser, and magnetic bar stirring was charged with toluene/diisopropylamine (3:2; 35 mL) and was degassed at room temperature by constant argon bubbling for 3 h. (4) (0.86 g, 1.964 mmol; 1.1 eq.), (6) (0.78 g, 1.785 mmol), (Ph₃P)₄Pd (1 mol %), and CuI (2.5 mol %) were added under argon atmosphere. The reaction mixture was stirred at room temperature for 30 minutes and then warmed at 70° C. for 1.5 h. The molecular weight of the polymer is controlled in part by the length of time and the temperature of the polymerization reaction. Diisopropylammonium salts were formed immediately after the start of the reaction and the reaction mixture became highly fluorescent. The warmed reaction mixture was then added slowly to an Erlenmeyer flask charged with vigorously stirred methanol (250 mL). The mixture was stirred for 2 h at room temperature and the orange precipitate was collected by filtration using a Buchner funnel equipped with a fritted disc. The orange solid was then washed with methanol-ammonium hydroxide solution (1:1; 100 mL) and then methanol (100 mL). After drying for 24 h under vacuum line at room temperature, PPE (7) was obtained as an orange solid (1.25 g). The repeated units of this PPE was estimated by ¹H NMR (using the integral of the end group) to be about 60. The polydispersity is about 1.4 as determined by GPC using polystyrene standards. This PPE was used in the dispersion of carbon nanotubes (CNTs). Increased exfoliation of CNTs was observed, which increased exfoliation is due to the electron donor/electron acceptor features of the polymer backbone.

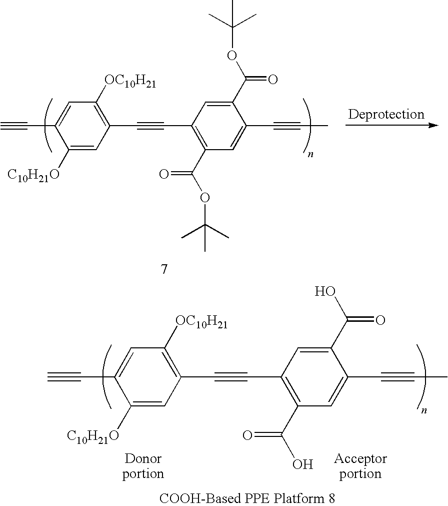

COOH-Based PPE platform (8): Potassium hydroxide (1.0 g) was dissolved in a mixture of toluene-ethanol (1:1; 30 mL) at reflux. PPE (7) (1.0 g) was added and the reaction mixture was stirred at reflux for 3 h. Water (10 mL) was then added and the reaction was refluxed for an additional 24 h. The reaction mixture was allowed to cool to room temperature and filtered. The filtrate was acidified by adding 3N HCl slowly. The orange precipitate was collected by filtration, washed with water (100 mL), and dried to give 0.75 g of COOH-PPE (8). This product is not soluble in chlorinated solvents but it is soluble in other solvents such as diethyl ether, THF, DMF, acetone, methyl ethyl ketone, isopropyl alcohol, methanol, ethanol, etc. PPE (8) is also soluble in a basic aqueous solution (pH superior or equal to 8).

PPE (8) is useful to disperse CNTs in water and in other solvents and is useful for constructing new PPE's with various side chains terminated with different functionalities (COOH, NH₂ NHR, OH, SH, etc).

Synthesis of PPE's Having Modified Acceptor Monomer Portions: Modular PPE's are also synthesized by varying the derivatization of reactant 6 in the polymerization reaction of Scheme 3. For example, in the following Scheme 4, reactant M2 is the same as reactant 4 of Scheme 3. Reactant M1 represents an electron acceptor diester monomer portion or a diamide monomer portion as shown below.

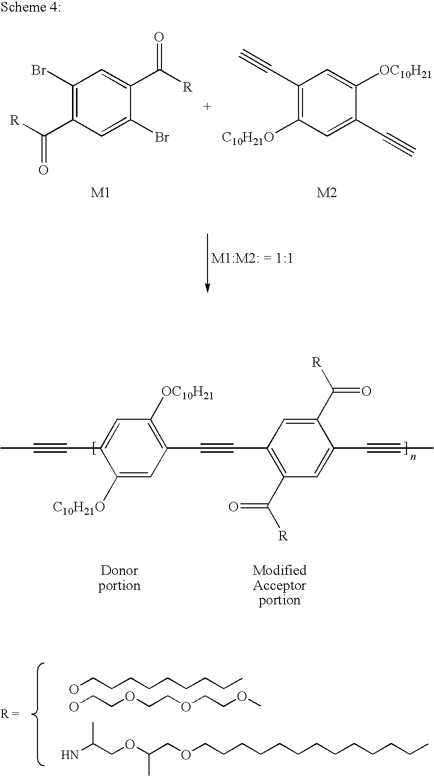

Three separate polymerizations were carried out with reactants M1 and M2 as shown above. The R group of M1 was different for each polymerization also as shown above. A 2000-mL, oven dried two-necked flask, equipped with a reflux condenser, and magnetic bar stirring was charged with toluene/diisopropylamine (4:1; 1100 mL) and was degassed at room temperature by constant argon bubbling for 3 h. M1 (30 mmol), M2 (30 mmol), (Ph₃P)₄Pd (1 mol %), and CuI (2.5 mol %) were added under argon atmosphere. The reaction mixture was stirred at room temperature for 30 minutes and then warmed at 70° C. for 1.5 h. Diisopropylammonium salts were formed immediately after the start of the reaction and the reaction mixture became highly fluorescent. The warmed reaction mixture was then added slowly to an Erlenmeyer flask charged with vigorously stirred methanol (1000 mL). The mixture was stirred for 2 h at room temperature and the orange precipitate was collected by filtration using a Buchner funnel equipped with a fritted disc. The orange solid was then washed with methanol-ammonium hydroxide solution (1:1; 500 mL) and then methanol (500 mL). After drying for 24 h under vacuum line at room temperature, the polymers were obtained with good yields (75% to 90%) as orange solids. The number of repeated units of these PPE's was estimated by ¹H NMR (using the integral of the end group) to be about 60. The polydispersity is about 1.4 as determined by GPC using polystyrene standards.

Synthesis of PPE's Having Diethynyl Acceptor Monomer Portion and Halo Donor Monomer Portion Modular PPE's are also synthesized by varying the derivatization of the diethynyl reactant and the halo reactant in the polymerization reaction of Scheme 3. For example, in the following scheme, the diethynyl reactant has electron withdrawing substituents and therefore provides the acceptor monomer portion and the halo reactant has electron donating substituents and therefore provides the donor monomer portion of the resultant PPE.

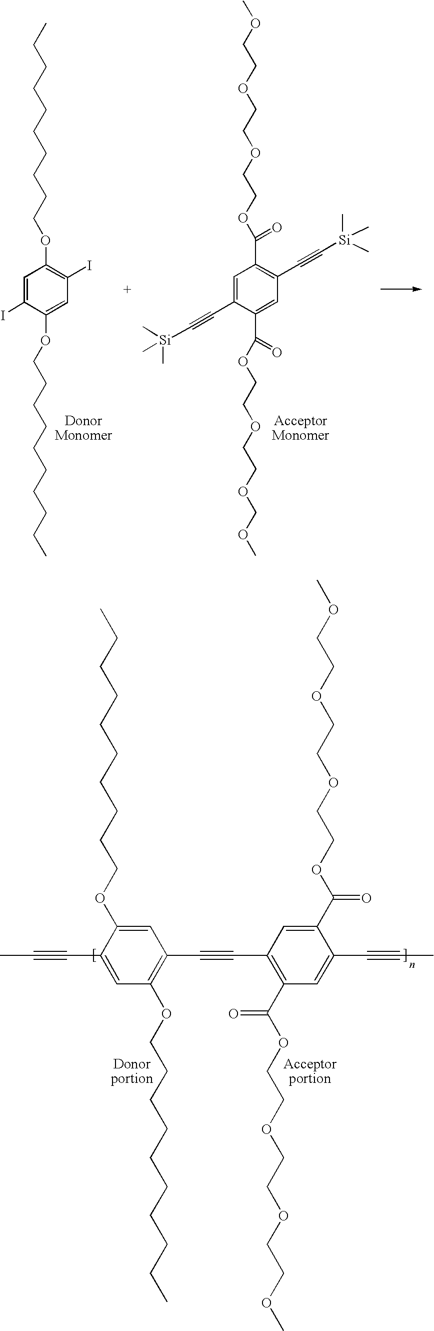

Synthesis: A 100-mL, oven dried two-necked flask, equipped with a reflux condenser, and magnetic bar stirring was charged with toluene/diisopropylamine (4:1; 30 mL), water (2.5 mL) and potassium carbonate (10 mmol) and was degassed at room temperature by constant argon bubbling for 3 h. Donor monomer portion (1.964 mmol), acceptor monomer portion (1.85 mmol), (Ph₃P)₄Pd (1 mol %), and CuI (2.5 mol %) were added under argon atmosphere. The reaction mixture was stirred at room temperature for 30 minutes and then warmed at 50° C. for 2 h. Diisopropylammonium salts were formed immediately after the start of the reaction and the reaction mixture became highly fluorescent. The temperature of the reaction mixture was then raised to 70° C. for an additional 6 h. The hot solution was then added slowly to an Erlenmeyer charged with vigorously stirred methanol (250 mL). The mixture was stirred for 2 h at room temperature and the orange precipitate was collected by filtration using Buchner funnel equipped with fritted disc. The orange solid was then washed with methanol-ammonium hydroxide solution (1:1; 100 mL) and then methanol (100 mL). After drying for 24 h under vacuum line at room temperature, the PPE polymer was obtained as an orange solid (1.25 g). The repeated units of this PPE was estimated by ¹H NMR (using the integral of the end group) to be about 60 to 80. The polydispersity is about 1.4-1.6 as determined by GPC using polystyrene standards.

### Example 2

### A PPE Platform Having Donor/Acceptor Monomer Portion Ratios Other than 1:1

Modular PPE's are not limited to having one donor monomer portion and one acceptor monomer portion per monomer unit of the polymer. For example, the following Scheme 5 is for synthesis of PPE having a donor/acceptor monomer portion ratio of 3:1. Third monomer portion M3 is provided for the extra donor phenyl reactants to preserve the stoichiometry of one diethynyl phenyl reactant alternating with one halo-substituted reactant in the polymer product.

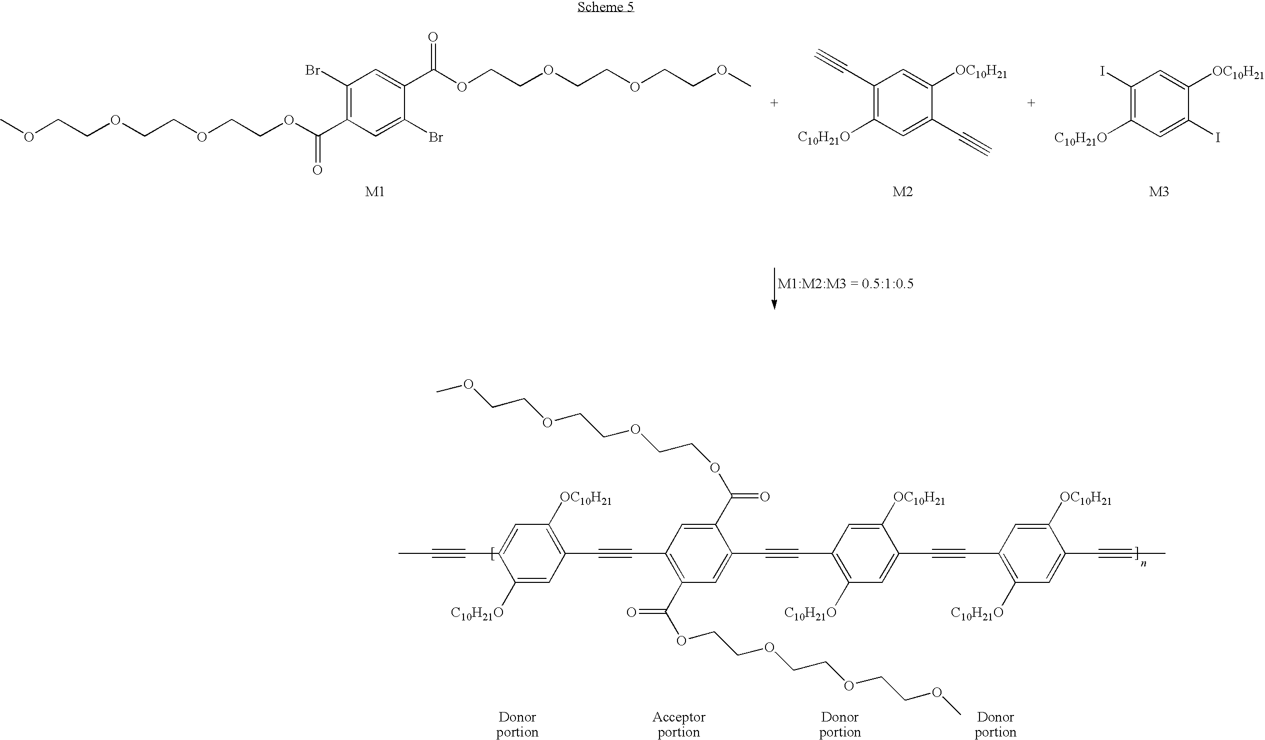

Synthesis of PPE Having a Donor/Acceptor Monomer Portion Ratio of 3:1: A 2000-mL, oven dried two-necked flask, equipped with a reflux condenser, and magnetic bar stirring was charged with toluene/diisopropylamine (4:1; 1100 mL) and was degassed at room temperature by constant argon bubbling for 3 h. M1 (15 mmol; 0.5 eq.), M2 (30 mmol), M3 (15 mmol; 0.5 eq.), (Ph₃P)₄Pd (1 mol %), and CuI (2.5 mol %) were added under argon atmosphere. The reaction mixture was stirred at room temperature for 30 minutes and then warmed at 70° C. for 1.5 h. Diisopropylammonium salts were formed immediately after the start of the reaction and the reaction mixture became highly fluorescent. The warmed reaction mixture was then added slowly to an Erlenmeyer flask charged with vigorously stirred methanol (1000 mL). The mixture was stirred for 2 h at room temperature and the orange precipitate was collected by filtration using a Buchner funnel equipped with a fritted disc. The orange solid was then washed with methanol-ammonium hydroxide solution (1:1; 500 mL) and then methanol (500 mL). After drying for 24 h under vacuum line at room temperature, PPE having a Donor/Acceptor monomer portion ratio of 3:1 was obtained as an orange solid (37.5 g). The repeated units of this PPE was estimated by ¹H NMR (using the integral of the end group) to be about 60. The polydispersity is about 1.4 as determined by GPC using polystyrene standards.

In general, the following Scheme 6 shows the reactant ratios needed for constructing PPE's having a donor/acceptor monomer portion ratio of 1:1, 3:1 and 7:1. One of ordinary skill in the art would be able to use a similar approach to prepare PPE's with further different ratios of the monomer portions, for example, reverse ratios of 1:3, or 1:7.

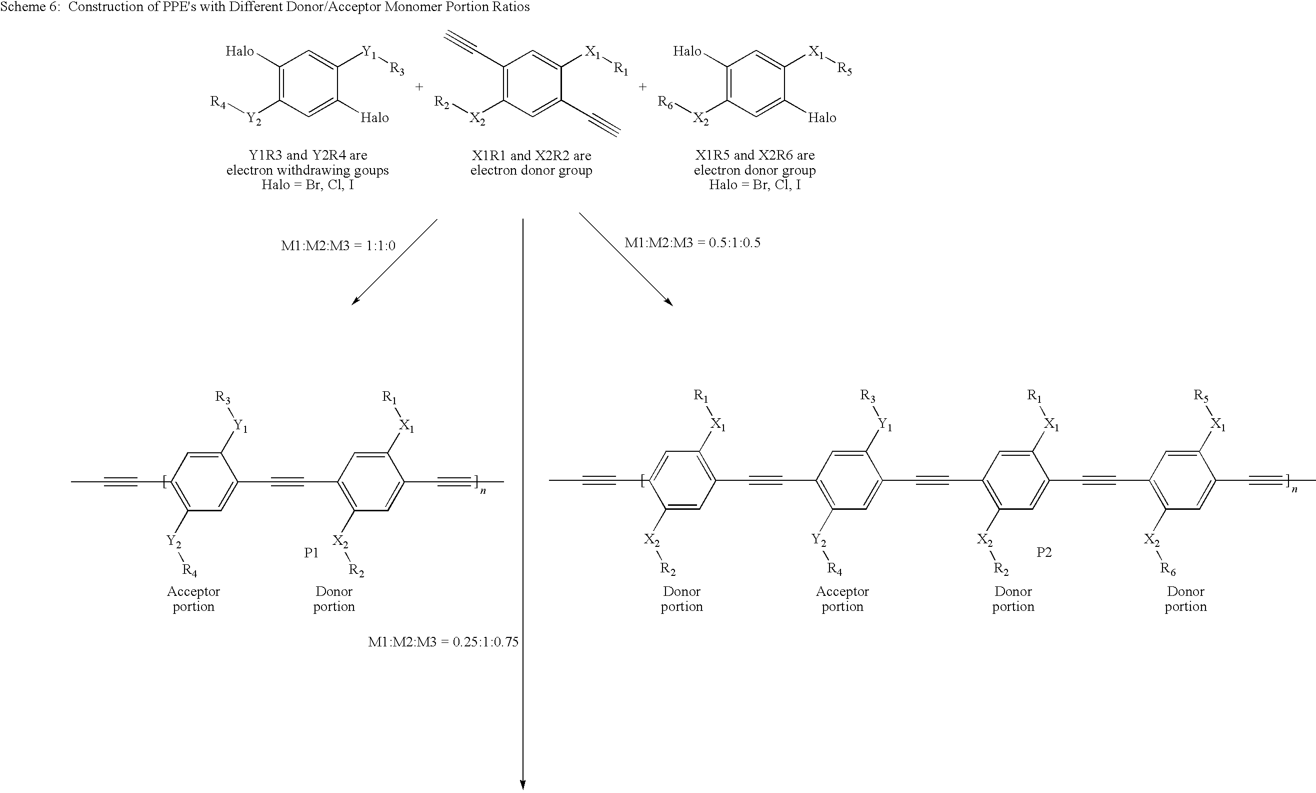

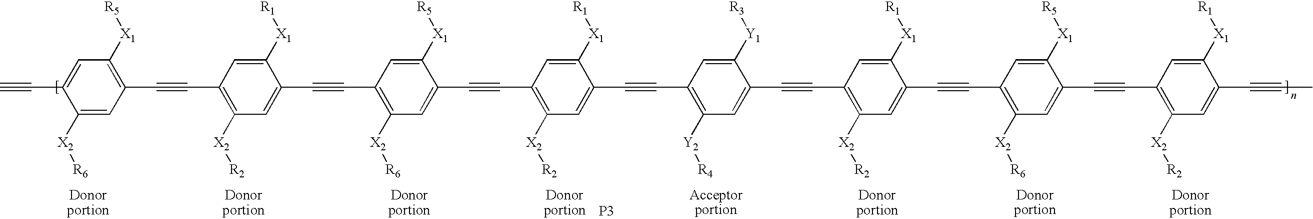

For Scheme 6, Y₁R₃ and Y₂R₄ are electron withdrawing groups, thereby the monomer portion M1 is an electron acceptor since the phenyl portion is electron deficient. X₁R₁, X₂R₂, X₁R₅, and X₂R₆ are electron donor groups, thereby the monomer portions M2 and M3 are electron donors since the phenyl portions are electron rich.

### Example 3

### Dispersions of Exfoliated Nanomaterial Using Modular Poly(Phenyleneethynylene)

Modular poly(phenyleneethynylene) polymers 7 and 8 were prepared according to Example 1. The polymers were mixed individually with multi-walled carbon nanotubes (MWNTs) and a dispersion/solubilization solvent in the amounts as indicated in Table 1. The mixtures were sonicated at 25° C. for about 30 min to produce dispersions of exfoliated nanotubes. After sonication, each of the mixtures had formed a stable solution. The MWNTs used in the present example are commercially available from the Arkema Group, France (Grade 4062).

TABLE 1
Dispersions of Exfoliated Nanotubes Using Modular PPE

| PPE | MWNTs | Modular | PPE:MWNTs | Dispersion | Conc. of MWNTs |
|---|---|---|---|---|---|
| No. | (mg) | PPE (mg) | weight ratio | Solvent (mL) | (mg/mL)* |
| 7 | 1500 | 300 | 0.2:1 | Methylethyl- | 6 mg/mL |
| | | | | ketone (MEK, | |
| | | | | 250) | |
| 8 | 2000 | 1000 | 0.5:1 | Water (250 mL) | 8 mg/mL |

*based on MWNT material only (excludes polymer material)

The dispersions of exfoliated nanotubes are uniform and stable for at least two weeks at room temperature. The dispersed material has a black color and can be filtered through a steel filter with a porosity of 10 to 20 microns without any loss of material. The dispersion with PPE 8 takes place under basic conditions at pH>than about 8 and the dispersed material could be dried to a powder form. This powder is then dispersible/soluble in solvents such as methanol, ethanol, or ethylene glycol, for example. Further, the dispersed material in water at basic pH could be precipitated out of the dispersion or solution by neutralization with a small amount of an acid. The filtration followed by drying give a powder which is dispersible/soluble in solvents such as DMSO, DMF, NMP, acetone, or MEK, for example.

For comparison purposes, a poly(phenyleneethynylene) having two donor units per monomer such as that described in Example 2 of copending U.S. patent application Ser. No. 10/920,877, filed Aug. 18, 2004 to Ait-Haddou, H., et al., which application is incorporated by reference herein in its entirety, was mixed with nanomaterial that had been pre-sonicated for 30 minutes to 3 hours. The mixtures were sonicated in chlorobenzene at 25° C. for about 30 min to produce solutions of exfoliated nanotubes of 2 mg/mL, 3 mg/mL, and up to 10-15 mg/mL as cited in the above-referenced patent application.

The nanomaterial of the present example was not pre-sonicated prior to mixing with modular PPE. Therefore, modular PPE of the present invention provides an advantage for exfoliating and dispersing nanomaterials as compared to the process of the above-referenced patent application.

The exemplary polymer platforms described herein provide methods for dispersion/solubilization and functionalization of nanomaterials, including but not limited to carbon nanotubes. In one example of dispersion/solubilization, the exemplary polymer platforms described herein exfoliates and disperses carbon nanotubes without requiring a sonication step. In one embodiment of the polymer platform for exfoliation of nanomaterials, such as carbon nanotubes, the platform is one that generates electron-rich and electron-poor areas on the polymer backbone.

While various examples above are described for dispersing/solubilizing carbon nanotubes, and more particularly multi-walled carbon nanotubes, embodiments of the present invention are not intended to be limited solely in application to carbon nanotubes. Nanotubes may be formed from various materials such as, for example, carbon, boron nitride, and composites thereof. The nanotubes may be single-walled nanotubes or multi-walled nanotubes. Thus, while examples are described herein above for dispersing/solubilizing carbon nanotubes, certain embodiments of the present invention may be utilized for dispersing/solubilizing various other types of nanotubes, including without limitation multi-walled carbon nanotubes (MWNTs), boron nitride nanotubes, and composites thereof. Accordingly, as used herein, the term “nanotubes” is not limited solely to carbon nanotubes.

Although the present invention and its advantages have been described in detail, it should be understood that various changes, substitutions and alterations can be made. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufactures, compositions of matter, means, methods, or steps, presently existing or later to be developed that perform substantially the same function or achieve substantially the same result as the corresponding embodiments described herein may be utilized according to the present invention.

What is claimed is:

1. A polymer for functionalizing nanomaterials comprising a poly(phenyleneethynylene) having the structure: 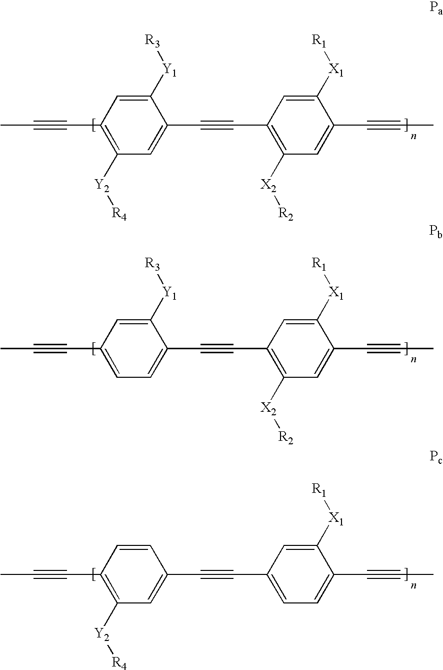
wherein
n is from about 20 to about 190;
X₁, X₂, Y₁ and Y₂ are independently selected from the group consisting of CO, COO, CONH, CONHCO, COOCO, CONHCNH, CON, COS, CS, alkyl, aryl, allyl, N, NO, S, O, CN, CNN, SO, SO₂, P and PO; and
R₁-R₄ are independently selected from the group consisting of alkyl, phenyl, benzyl, aryl, allyl, or hydrogen; wherein:
when X₁, X₂, Y₁ or Y₂ is CO, COO, CONH, CONHCO, COOCO, CONHCNH, CON, COS, CS, CN, CNN, SO, SO₂, NO or PO then X₁R₁, X₂R₂, Y₁R₃, Y₂R₄ or Y₂R₂ is an electron withdrawing substituent;
when X₁, X₂, Y₁ or Y₂ is alkyl, aryl, allyl, N, S, O or P then X₁R₁, X₂R₂, Y₁R₃, Y₂R₄ or Y₂R₂ is an electron donating substituent;
when the poly(phenyleneethynylene) has the structure Pₐ and X₁R₁ is an electron donating substituent, then X₂R₂ is an electron donating substituent and Y₁R₃ and Y₂R₄ are electron withdrawing substituents;
when the poly(phenyleneethynylene) has the structure Pₐ and X₁R₁ is an electron withdrawing substituent, then X₂R₂ is an electron withdrawing substituent and Y₁R₃ and Y₂R₄ are electron donating substituents;
when the poly(phenyleneethynylene) has the structure P_{b} and X₁R₁ is an electron donating substituent then X₂R₂ is an electron donating substituent and Y₁R₃ is an electron withdrawing substituent;
when the poly(phenyleneethynylene) has the structure P_{b} and X₁R₁ is an electron withdrawing substituent then X₂R₂ is an electron withdrawing substituent and Y₁R₃ is an electron donating substituent;
when the poly(phenyleneethynylene) has the structure P_{c} and X₁R₁ is an electron donating substituent, then Y₂R₂ is an electron withdrawing substituent; and
when the poly(phenyleneethynylene) has the structure P_{c} and X₁R₁ is an electron withdrawing substituent, then Y₂R₂ is an electron donating substituent.

2. The composition of claim 1 wherein the poly(phenyleneethynylene) has the structure Pₐ, X₁R₁═X₂R₂ and Y₁R₃═Y₂R₄.

3. The composition of claim 1 wherein the poly(phenyleneethynylene) has the structure Pₐ, X₁═X₂═COO, Y₁═Y₂═O.

4. The composition of claim 1 wherein the poly(phenyleneethynylene) has the structure P_{b}, and X₁R₁═X₂R₂.

5. The composition of claim 1 wherein the poly(phenyleneethynylene) has the structure P_{b}, X₁═X₂═COO, Y₁═O.

6. The composition of claim 1 wherein the poly(phenyleneethynylene) has the structure P_{c}, X₁═COO, Y₂═O.

7. The composition of claim 1 wherein the poly(phenyleneethynylene) has the structure Pₐ, X₁R₁═X₂R₂═COOH, and Y₁R₃═Y₂R₄═OC₁₀H₂₁.

8. The composition of claim 1 wherein the poly(phenyleneethynylene) has the structure Pₐ, X₁R₁═X₂R₂═COOC(CH₃)₃, and Y₁R₃═Y₂R₄═OC₁₀H₂₁.

9. The composition of claim 1 wherein the poly(phenyleneethynylene) has the structure Pₐ, X₁R₁═X₂R₂═COO-alkyl, and Y₁R₃═Y₂R₄═OC₁₀H₂₁.

11. The composition of claim 1 wherein at least one of R₁, R₂, R₃, or R₄ is further bound to a group Z where Z is independently an acetal, acid halide, acrylate unit, acyl azide, aldehyde, anhydride, cyclic alkene, arene, alkene, alkyne, alkyl halide, aryl, aryl halide, amine, amide, amino, amino acid, alcohol, alkoxy, antibiotic, azide, aziridine, azo compounds, calixarene, carbohydrate, carbonate, carboxylic acid, carboxylate, carbodiimide, cyclodextrin, crown ether, CN, cryptand, dendrimer, dendron, diamine, diaminopyridine, diazonium compounds, DNA, epoxy, ester, ether, epoxide, ethylene glycol, fullerene, glyoxal, halide, hydroxy, imide, imine, imidoester, ketone, nitrile, isothiocyanate, isocyanate, isonitrile, ketone, lactone, ligand for metal complexation, ligand for biomolecule complexation, lipid, maleimide, melamine, metallocene, NHS ester, nitroalkane, nitro compounds, nucleotide, olefin, oligosaccharide, peptide, phenol, phthalocyanine, porphyrin, phosphine, phosphonate, polyamine, polyethoxyalkyl, 2,2′-bipyridine, 1,10-phenanthroline, terpyridine, pyridazine, pyrimidine, purine, pyrazine, 1,8-naphthyridine, polyhedral oligomeric silsequioxane (POSS), pyrazolate, imidazolate, torand, hexapyridine, 4,4′-bipyrimidine, polypropoxyalkyl, protein, pyridine, quaternary ammonium salt, quaternary phosphonium salt, quinone, RNA, Schiff base, selenide, sepulchrate, silane, a styrene unit, sulfide, sulfone, sulfhydryl, sulfonyl chloride, sulfonic acid, sulfonic acid ester, sulfonium salt, sulfoxide, sulfur and selenium compounds, thiol, thioether, thiol acid, thio ester, thymine, or a combination thereof.

12. The composition of claim 11 wherein the poly(phenyleneethynylene) has the structure Pₐ, X₁R₁Z=X₂R₂Z=COO-polyethoxyalkyl, and Y₁R₃═Y₂R₄═OC₁₀H₂₁.

13. The composition of claim 11 wherein the poly(phenyleneethynylene) has the structure Pₐ, X₁R₁Z=X₂R₂Z=CONHCH(CH3)CH2OCH(CH3)CH2Oalkyl, and Y₁R₃═Y₂R₄═OC₁₀H₂₁.
